(19) United States
(12) Patent Application Publication
(10) Pub. No.: US 2023/0101379 A1
(43) Pub. Date: Mar. 30, 2023

(54) PRIORITY AND COLLISION FOR COLLIDING POSITIONING STATE INFORMATION (PSI) REPORTS

(71) Applicant: QUALCOMM INCORPORATED, San Diego, CA (US)

(72) Inventors: Alexandros MANOLAKOS, Escondido, CA (US); Krishna Kiran MUKKAVILLI, San Diego, CA (US); Tingfang JI, San Diego, CA (US)

(21) Appl. No.: 17/800,889

(22) PCT Filed: Dec. 17, 2020
(86) PCT No.: PCT/US2020/065713

§ 371 Date: Aug. 18, 2022

(30) Foreign Application Priority Data
Feb. 19, 2020 (GR) 20200100083

(51) Int. Cl. G01S 5/00; H04W 24/08; H04W 64/00; H04W 72/566; H04W 72/21

(52) U.S. Cl. CPC G01S 5/0036; H04W 24/08; H04W 64/00; H04W 72/21; H04W 72/569

(57) ABSTRACT

A user equipment (UE) generates a positioning state information (PSI) report to be transmitted in a lower layer channel, e.g., in the Physical or Medium Access Control channel, to a network entity to reduce latency. The PSI reports may be generated based on information from uplink (UL), downlink (DL) or UL and DL positioning measurements performed by the UE. When multiple PSI reports collide, e.g., to be transmitted simultaneously, or when a PSI report and a Channel State Information (CSI) report collide, prioritization of the reports is performed using priority rules based at least in part on positioning related content of the PSI reports. The PSI report or CSI report with the highest priority is transmitted to the network entity on the lower layer channel, and lower priority reports may be omitted. A network entity may receive and process the PSI report based on the priority based rules.

### BACKGROUND OF THE DISCLOSURE

### 1. Field of the Disclosure

Aspects of the disclosure relate generally to wireless communications and the like.

### 2. Description of the Related Art

Wireless communication systems have developed through various generations, including a first-generation analog wireless phone service (1G), a second-generation (2G) digital wireless phone service (including interim 2.5G networks), a third-generation (3G) high speed data, Internet-capable wireless service, and a fourth-generation (4G) service (e.g., Long-Term Evolution (LTE), WiMax). There are presently many different types of wireless communication systems in use, including cellular and personal communications service (PCS) systems. Examples of known cellular systems include the cellular Analog Advanced Mobile Phone System (AMPS), and digital cellular systems based on code division multiple access (CDMA), frequency division multiple access (FDMA), time division multiple access (TDMA), the Global System for Mobile access (GSM) variation of TDMA, etc.

A fifth generation (5G) mobile standard calls for higher data transfer speeds, greater numbers of connections, and better coverage, among other improvements. The 5G standard (also referred to as “New Radio” or “NR”), according to the Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments. Consequently, the spectral efficiency of 5G mobile communications should be significantly enhanced compared to the current 4G / LTE standard. Furthermore, signaling efficiencies should be enhanced and latency should be substantially reduced compared to current standards.

### SUMMARY

A user equipment (UE) generates a positioning state information (PSI) report to be transmitted in a lower layer channel, e.g., in the Physical or Medium Access Control channel, to a network entity to reduce latency. The PSI reports may be generated based on information from uplink (UL), downlink (DL) or UL and DL positioning measurements performed by the UE. When multiple PSI reports collide, e.g., are to be transmitted simultaneously, or when a PSI report and a Channel State Information (CSI) report collide, prioritization of the reports is performed using priority rules based at least in part on positioning related content of the PSI reports. The PSI report or CSI report with the highest priority is transmitted to the network entity on the lower layer channel, and lower priority reports may be omitted. A network entity may receive and process the PSI report based on the priority based rules.

In one implementation, a method for a user equipment (UE) wireless communications performed by the UE, includes determining a plurality of positioning state information (PSI) reports to be transmitted on a lower layer channel, wherein each of the plurality of PSI reports comprises information related to a plurality of positioning measurements performed by the UE; detecting a collision of the plurality of PSI reports to be transmitted on the lower layer channel; performing prioritization of the plurality of PSI reports using one or more priority rules based at least in part on positioning related content of each of the plurality of PSI reports; and transmitting one PSI report from the plurality of PSI reports based on prioritization to a network entity on the lower layer channel.

In one implementation, a user equipment (UE) configured for wireless communications, includes a wireless transceiver configured to wirelessly communicate with a network entity in a wireless communication system; at least one memory; at least one processor coupled to the wireless transceiver and the at least one memory, wherein the at least one processor is configured to: determine a plurality of positioning state information (PSI) reports to be transmitted on a lower layer channel, wherein each of the plurality of PSI reports comprises information related to plurality of positioning measurements performed by the UE; detect a collision of the plurality of PSI reports to be transmitted on the lower layer channel; perform prioritization of the plurality of PSI reports using one or more priority rules based at least in part on positioning related content of each of the plurality of PSI reports; and transmit one PSI report from the plurality of PSI reports based on prioritization to the network entity on the lower layer channel.

In one implementation, a user equipment (UE) configured for wireless communications, includes means for determining a plurality of positioning state information (PSI) reports to be transmitted on a lower layer channel, wherein each of the plurality of PSI reports comprises information related to plurality of positioning measurements performed by the UE; means for detecting a collision of the plurality of PSI reports to be transmitted on the lower layer channel; means for performing prioritization of the plurality of PSI reports using one or more priority rules based at least in part on positioning related content of each of the plurality of PSI reports; and means for transmitting one PSI report from the plurality of PSI reports based on prioritization to a network entity on the lower layer channel.

In one implementation, a non-transitory storage medium including program code stored thereon, the program code is operable to configure at least one processor in a user equipment (UE) for wireless communications, includes program code to determine a plurality of positioning state information (PSI) reports to be transmitted on a lower layer channel, wherein each of the plurality of PSI reports comprises information related to plurality of positioning measurements performed by the UE; program code to detect a collision of the plurality of PSI reports to be transmitted on the lower layer channel; program code to perform prioritization of the plurality of PSI reports using one or more priority rules based at least in part on positioning related content of each of the plurality of PSI reports; and program code to transmit one PSI report from the plurality of PSI reports based on prioritization to a network entity on the lower layer channel.

In one implementation, a method for a user equipment (UE) wireless communications performed by the UE, includes determining a positioning state information (PSI) report to be transmitted on a lower layer channel, wherein the PSI report comprises content related to positioning measurements performed by the UE; determining a channel state information (CSI) report to be transmitted on the lower layer channel; detecting a collision of the PSI report and the CSI report to be transmitted on the lower layer channel; performing prioritization of the PSI report and CSI report using one or more priority rules; and transmitting one of the PSI report and the CSI report based on prioritization to a network entity on the lower layer channel.

In one implementation, a user equipment (UE) configured for wireless communications, includes a wireless transceiver configured to wirelessly communicate with a network entity in a wireless communication system; at least one memory; at least one processor coupled to the wireless transceiver and the at least one memory, wherein the at least one processor is configured to: determine a positioning state information (PSI) report to be transmitted on a lower layer channel, wherein the PSI report comprises content related to positioning measurements performed by the UE; determine a channel state information (CSI) report to be transmitted on the lower layer channel; detect a collision of the PSI report and the CSI report to be transmitted on the lower layer channel; perform prioritization of the PSI report and CSI report using one or more priority rules; and transmit one of the PSI report and the CSI report based on prioritization to the network entity on the lower layer channel.

In one implementation, a user equipment (UE) configured for wireless communications, includes means for determining a positioning state information (PSI) report to be transmitted on a lower layer channel, wherein the PSI report comprises content related to positioning measurements performed by the UE; means for determining a channel state information (CSI) report to be transmitted on the lower layer channel; means for detecting a collision of the PSI report and the CSI report to be transmitted on the lower layer channel; means for performing prioritization of the PSI report and CSI report using one or more priority rules; and means for transmitting one of the PSI report and the CSI report based on prioritization to a network entity on the lower layer channel.

In one implementation, a non-transitory storage medium including program code stored thereon, the program code is operable to configure at least one processor in a user equipment (UE) for wireless communications, includes program code to determine a positioning state information (PSI) report to be transmitted on a lower layer channel, wherein the PSI report comprises content related to positioning measurements performed by the UE; program code to determine a channel state information (CSI) report to be transmitted on the lower layer channel; program code to detect a collision of the PSI report and the CSI report to be transmitted on the lower layer channel; program code to perform prioritization of the PSI report and CSI report using one or more priority rules; and program code to transmit one of the PSI report and the CSI report based on prioritization to a network entity on the lower layer channel.

In one implementation, a method for a user equipment (UE) wireless communications performed by a network entity in a wireless network, includes receiving from the UE a positioning state information (PSI) report in a lower layer channel, the PSI report comprising information related to positioning measurements performed by the UE, wherein the PSI report was prioritized over a second colliding PSI report using one or more priority rules based at least in part on positioning related content of the PSI report and the second colliding PSI report; and processing the PSI report.

In one implementation, a network entity in a wireless network configured to support wireless communications of a user equipment (UE), includes an external interface configured to wirelessly communicate with the UE; at least one memory; at least one processor coupled to the external interface and the at least one memory, wherein the at least one processor is configured to: receive from the UE a positioning state information (PSI) report in a lower layer channel, the PSI report comprising information related to positioning measurements performed by the UE, wherein the PSI report was prioritized over a second colliding PSI report using one or more priority rules based at least in part on positioning related content of the PSI report and the second colliding PSI report; and process the PSI report.

In one implementation, a network entity in a wireless network configured to support wireless communications of a user equipment (UE), includes means for receiving from the UE a positioning state information (PSI) report in a lower layer channel, the PSI report comprising information related to positioning measurements performed by the UE, wherein the PSI report was prioritized over a second colliding PSI report using one or more priority rules based at least in part on positioning related content of the PSI report and the second colliding PSI report; and means for processing the PSI report.

In one implementation, a non-transitory storage medium including program code stored thereon, the program code is operable to configure at least one processor in a network entity in a wireless network to support wireless communications of a user equipment (UE), includes program code to receive from the UE a positioning state information (PSI) report in a lower layer channel, the PSI report comprising information related to positioning measurements performed by the UE, wherein the PSI report was prioritized over a second colliding PSI report using one or more priority rules based at least in part on positioning related content of the PSI report and the second colliding PSI report; and program code to process the PSI report.

In one implementation, a method for a user equipment (UE) wireless communications performed by a network entity in a wireless network, includes receiving from the UE one of a channel state information (CSI) report or a positioning state information (PSI) report transmitted on a lower layer channel, the CSI report comprising content including one or more of a Channel Quality Information (CQI), Precoding Matrix Indicator (PMI), Rank Indicator (RI), Layer Indicator (LI), and Layer 1 Reference Signal Receive Power (L1-RSRP) and the PSI report comprising information related to positioning measurements performed by the UE, wherein the CSI report and the PSI report were colliding and the one of the CSI report or the PSI report was prioritized for transmission by the UE using one or more priority rules; and processing the one of the CSI report or the PSI report that is received.

In one implementation, a network entity in a wireless network configured to support wireless communications of a user equipment (UE), includes an external interface configured to wirelessly communicate with the UE; at least one memory; at least one processor coupled to the external interface and the at least one memory, wherein the at least one processor is configured to: receive from the UE one of a channel state information (CSI) report or a positioning state information (PSI) report transmitted on a lower layer channel, the CSI report comprising content including one or more of a Channel Quality Information (CQI), Precoding Matrix Indicator (PMI), Rank Indicator (RI), Layer Indicator (LI), and Layer 1 Reference Signal Receive Power (L1-RSRP) and the PSI report comprising information related to positioning measurements performed by the UE, wherein the CSI report and the PSI report were colliding and the one of the CSI report or the PSI report was prioritized for transmission by the UE using one or more priority rules; and process the one of the CSI report or the PSI report that is received.

In one implementation, a network entity in a wireless network configured to support wireless communications of a user equipment (UE), includes means for receiving from the UE one of a channel state information (CSI) report or a positioning state information (PSI) report transmitted on a lower layer channel, the CSI report comprising content including one or more of a Channel Quality Information (CQI), Precoding Matrix Indicator (PMI), Rank Indicator (RI), Layer Indicator (LI), and Layer 1 Reference Signal Receive Power (L1-RSRP) and the PSI report comprising information related to positioning measurements performed by the UE, wherein the CSI report and the PSI report were colliding and the one of the CSI report or the PSI report was prioritized for transmission by the UE using one or more priority rules; and means for processing the one of the CSI report or the PSI report that is received.

In one implementation, a non-transitory storage medium including program code stored thereon, the program code is operable to configure at least one processor in a network entity in a wireless network to support wireless communications of a user equipment (UE), includes program code to receive from the UE one of a channel state information (CSI) report or a positioning state information (PSI) report transmitted on a lower layer channel, the CSI report comprising content including one or more of a Channel Quality Information (CQI), Precoding Matrix Indicator (PMI), Rank Indicator (RI), Layer Indicator (LI), and Layer 1 Reference Signal Receive Power (L1-RSRP) and the PSI report comprising information related to positioning measurements performed by the UE, wherein the CSI report and the PSI report were colliding and the one of the CSI report or the PSI report was prioritized for transmission by the UE using one or more priority rules; and program code to process the one of the CSI report or the PSI report that is received.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an exemplary wireless communications system, according to various aspects of the disclosure.

FIGS. 2A and 2B illustrate example wireless network structures, according to various aspects of the disclosure.

FIG. 3 illustrates a block diagram of a design of base station and user equipment (UE), which may be one of the base stations and one of the UEs in FIG. 1.

FIG. 4 is a diagram of a structure of an exemplary subframe sequence with positioning reference signal (PRS) positioning occasions.

FIG. 5 is a block diagram illustrating a UE configured to prioritize colliding Positioning State Information (PSI) reports based at least in part on positioning related content and to transmit the higher priority PSI report on a lower layer channel to a network entity, according to the disclosure herein.

FIG. 6 is a block diagram illustrating a UE configured to prioritize a colliding PSI report and Channel State Information (CSI) report based at least in part on positioning related content and to transmit the higher priority report on a lower layer channel to a network entity, according to the disclosure herein.

FIG. 7 is a message flow with various messages sent between components of the communication system, illustrating the prioritization of colliding PSI reports or colliding PSI and CSI reports based at least in part on positioning related content and to transmitting the higher priority report on a lower layer channel to a network entity, according to the disclosure herein.

FIG. 8 is a flowchart for an exemplary method for wireless communications for a UE in which the UE prioritizes colliding PSI reports based at least in part on positioning related content and transmits the higher priority PSI report on a lower layer channel to a network entity, according to the disclosure herein.

FIG. 9 is a flowchart for an exemplary method for wireless communications for a UE in which the UE prioritizes colliding PSI and CSI reports based at least in part on positioning related content and transmits the higher priority report on a lower layer channel to a network entity, according to the disclosure herein.

FIG. 10 is a flowchart for an exemplary method for wireless communications for a UE in which the network enables a UE to prioritize colliding PSI reports based at least in part on positioning related content and to receive the higher priority PSI report transmitted by the UE on a lower layer channel, according to the disclosure herein.

FIG. 11 is a flowchart for an exemplary method for wireless communications for a UE in which the network enables a UE to prioritize colliding PSI and CSI reports based at least in part on positioning related content and to receive the higher priority report transmitted by the UE on a lower layer channel, according to the disclosure herein.

FIG. 12 shows a schematic block diagram illustrating certain exemplary features of a UE enabled to prioritize colliding PSI reports and/or colliding PSI and CSI reports based at least in part on positioning related content and to transmit the higher priority report on a lower layer channel to a network entity, according to the disclosure herein.

FIG. 13 shows a schematic block diagram illustrating certain exemplary features of a network entity in a wireless network enabled to support wireless communications with a UE to enable the UE to prioritize colliding PSI reports and/or colliding PSI and CSI reports based at least in part on positioning related content and to receive the higher priority report transmitted by the UE on a lower layer channel, according to the disclosure herein.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” are not intended to be specific or otherwise limited to any particular Radio Access Technology (RAT), unless otherwise noted. In general, a UE may be any wireless communication device (e.g., a mobile phone, router, tablet computer, laptop computer, tracking device, wearable (e.g., smartwatch, glasses, augmented reality (AR) / virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a Radio Access Network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or UT, a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11, etc.) and so on.

A base station may operate according to one of several RATs in communication with UEs depending on the network in which it is deployed, and may be alternatively referred to as an access point (AP), a network node, a NodeB, an evolved NodeB (eNB), a New Radio (NR) Node B (also referred to as a gNB or gNodeB), etc. In addition, in some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an UL / reverse or DL / forward traffic channel.

The term “base station” may refer to a single physical transmission point or to multiple physical transmission points that may or may not be co-located. For example, where the term “base station” refers to a single physical transmission point, the physical transmission point may be an antenna of the base station corresponding to a cell of the base station. Where the term “base station” refers to multiple co-located physical transmission points, the physical transmission points may be an array of antennas (e.g., as in a multiple-input multiple-output (MIMO) system or where the base station employs beamforming) of the base station. Where the term “base station” refers to multiple non-co-located physical transmission points, the physical transmission points may be a distributed antenna system (DAS) (a network of spatially separated antennas connected to a common source via a transport medium) or a remote radio head (RRH) (a remote base station connected to a serving base station). Alternatively, the non-co-located physical transmission points may be the serving base station receiving the measurement report from the UE and a neighbor base station whose reference RF signals the UE is measuring.

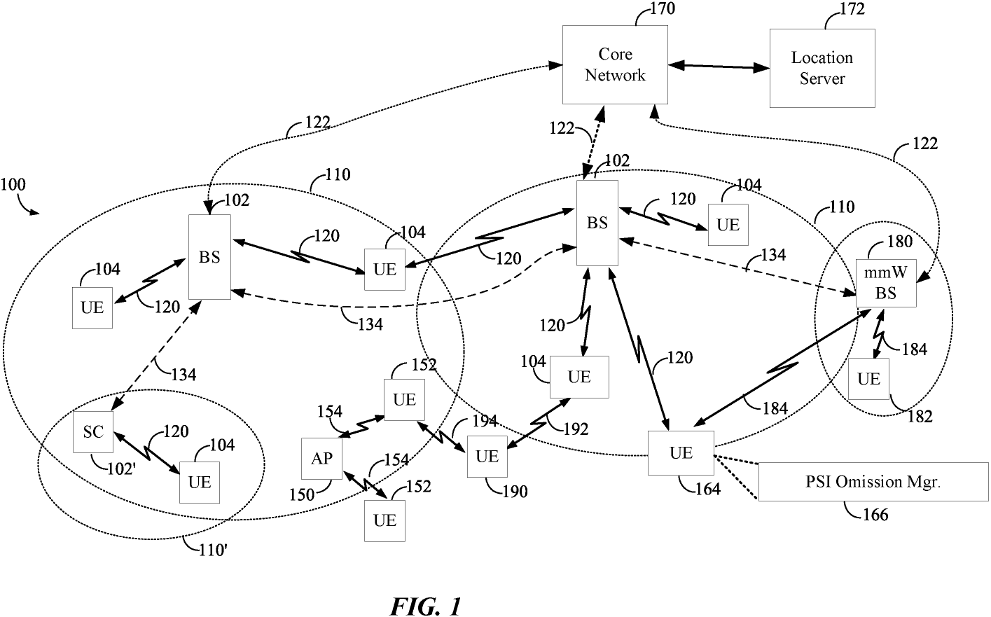

FIG. 1 illustrates an exemplary wireless communications system 100. The wireless communications system 100 (which may also be referred to as a wireless wide area network (WWAN)) may include various base stations 102 and various UEs 104. The base stations 102 may include macro cell base stations (high power cellular base stations) and/or small cell base stations (low power cellular base stations). In an aspect, the macro cell base station may include eNBs where the wireless communications system 100 corresponds to an LTE network, or gNBs where the wireless communications system 100 corresponds to a 5G network, or a combination of both, and the small cell base stations may include femtocells, picocells, microcells, etc.

The base stations 102 may collectively form a RAN and interface with a core network 170 (e.g., an evolved packet core (EPC) or next generation core (NGC)) through backhaul links 122, and through the core network 170 to one or more location servers 172. In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC / NGC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCID), a virtual cell identifier (VCID)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102' may have a coverage area 110' that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include UL (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to DL and UL (e.g., more or less carriers may be allocated for DL than for UL).

The wireless communications system 100 may further include a wireless local area network (WLAN) access point (AP) 150 in communication with WLAN stations (STAs) 152 via communication links 154 in an unlicensed frequency spectrum (e.g., 5 GHz). When communicating in an unlicensed frequency spectrum, the WLAN STAs 152 and/or the WLAN AP 150 may perform a clear channel assessment (CCA) prior to communicating in order to determine whether the channel is available.

The small cell base station 102' may operate in a licensed and/or an unlicensed frequency spectrum. When operating in an unlicensed frequency spectrum, the small cell base station 102' may employ LTE or 5G technology and use the same 5 GHz unlicensed frequency spectrum as used by the WLAN AP 150. The small cell base station 102', employing LTE / 5G in an unlicensed frequency spectrum, may boost coverage to and/or increase capacity of the access network. LTE in an unlicensed spectrum may be referred to as LTE-unlicensed (LTE-U), licensed assisted access (LAA), or MulteFire.

The wireless communications system 100 may further include a millimeter wave (mmW) base station 180 that may operate in mmW frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

In 5G, the frequency spectrum in which wireless nodes (e.g., base stations 102/180, UEs 104/182) operate is divided into multiple frequency ranges, FR1 (from 450 to 6000 MHz), FR2 (from 24250 to 52600 MHz), FR3 (above 52600 MHz), and FR4 (between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels. A secondary carrier is a carrier operating on a second frequency (e.g., FR2) that may be configured once the RRC connection is established between the UE 104 and the anchor carrier and that may be used to provide additional radio resources. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency / component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

The wireless communications system 100 may further include one or more UEs, such as UE 190, that connects indirectly to one or more communication networks via one or more device-to-device (D2D) peer-to-peer (P2P) links. In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WiFi Direct (WiFi-D), Bluetooth®, and so on.

The wireless communications system 100 may further include a UE 164 that may communicate with a macro cell base station 102 over a communication link 120 and/or the mmW base station 180 over a mmW communication link 184. For example, the macro cell base station 102 may support a PCell and one or more SCells for the UE 164 and the mmW base station 180 may support one or more SCells for the UE 164. In an aspect, the UE 164 may include a PSI omission manager 166 that may enable the UE 164 to perform the UE operations described herein. Note that although only one UE in FIG. 1 is illustrated as having a PSI omission manager 166, any of the UEs in FIG. 1 may be configured to perform the UE operations described herein.

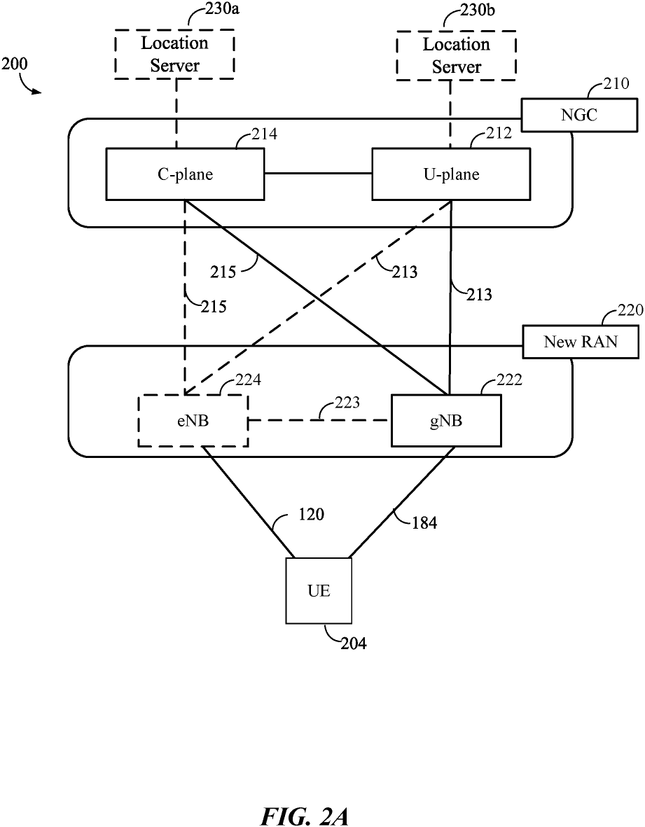

FIG. 2A illustrates an example wireless network structure 200. For example, an NGC 210 (also referred to as a “5GC”) can be viewed functionally as control plane functions 214 (e.g., UE registration, authentication, network access, gateway selection, etc.) and user plane functions 212, (e.g., UE gateway function, access to data networks, IP routing, etc.) which operate cooperatively to form the core network. User plane interface (NG-U) 213 and control plane interface (NG-C) 215 connect the gNB 222 to the NGC 210 and specifically to the control plane functions 214 and user plane functions 212. In an additional configuration, an eNB 224 may also be connected to the NGC 210 via NG-C 215 to the control plane functions 214 and NG-U 213 to user plane functions 212. Further, eNB 224 may directly communicate with gNB 222 via a backhaul connection 223. In some configurations, the New RAN 220 may only have one or more gNBs 222, while other configurations include one or more of both eNBs 224 and gNBs 222. Either gNB 222 or eNB 224 may communicate with UEs 204 (e.g., any of the UEs depicted in FIG. 1). Another optional aspect may include one or more location servers 230a, 230b (sometimes collectively referred to as location server 230) (which may correspond to location server 172), which may be in communication with the control plane functions 214 and user plane functions 212, respectively, in the NGC 210 to provide location assistance for UEs 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, NGC 210, and/or via the Internet (not illustrated). Further, the location server 230 may be integrated into a component of the core network, or alternatively may be external to the core network, e.g., in the New RAN 220.

FIG. 2B illustrates another example wireless network structure 250. For example, an NGC 260 (also referred to as a “5GC”) can be viewed functionally as control plane functions, provided by an access and mobility management function (AMF) 264, user plane function (UPF) 262, a session management function (SMF) 266, SLP 268, and an LMF 270, which operate cooperatively to form the core network (i.e., NGC 260). User plane interface 263 and control plane interface 265 connect the ng-eNB 224 to the NGC 260 and specifically to UPF 262 and AMF 264, respectively. In an additional configuration, a gNB 222 may also be connected to the NGC 260 via control plane interface 265 to AMF 264 and user plane interface 263 to UPF 262. Further, eNB 224 may directly communicate with gNB 222 via the backhaul connection 223, with or without gNB direct connectivity to the NGC 260. In some configurations, the New RAN 220 may only have one or more gNBs 222, while other configurations include one or more of both ng-eNBs 224 and gNBs 222. Either ng-gNB 222 or eNB 224 may communicate with UEs 204 (e.g., any of the UEs depicted in FIG. 1). The base stations of the New RAN 220 communicate with the AMF 264 over the N2 interface and the UPF 262 over the N3 interface.

The functions of the AMF include registration management, connection management, reachability management, mobility management, lawful interception, transport for session management (SM) messages between the UE 204 and the SMF 266, transparent proxy services for routing SM messages, access authentication and access authorization, transport for short message service (SMS) messages between the UE 204 and the short message service function (SMSF) (not shown), and security anchor functionality (SEAF). The AMF also interacts with the authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF retrieves the security material from the AUSF. The functions of the AMF also include security context management (SCM). The SCM receives a key from the SEAF that it uses to derive access-network specific keys. The functionality of the AMF also includes location services management for regulatory services, transport for location services messages between the UE 204 and the location management function (LMF) 270 (which may correspond to location server 172), as well as between the New RAN 220 and the LMF 270, evolved packet system (EPS) bearer identifier allocation for interworking with the EPS, and UE 204 mobility event notification. In addition, the AMF also supports functionalities for non-Third Generation Partnership Project (3GPP) access networks.

Functions of the UPF include acting as an anchor point for intra-/inter-RAT mobility (when applicable), acting as an external protocol data unit (PDU) session point of interconnect to the data network (not shown), providing packet routing and forwarding, packet inspection, user plane policy rule enforcement (e.g., gating, redirection, traffic steering), lawful interception (user plane collection), traffic usage reporting, quality of service (QoS) handling for the user plane (e.g., UL/DL rate enforcement, reflective QoS marking in the DL), UL traffic verification (service data flow (SDF) to QoS flow mapping), transport level packet marking in the UL and DL, DL packet buffering and DL data notification triggering, and sending and forwarding of one or more “end markers” to the source RAN node.

The functions of the SMF 266 include session management, UE Internet protocol (IP) address allocation and management, selection and control of user plane functions, configuration of traffic steering at the UPF to route traffic to the proper destination, control of part of policy enforcement and QoS, and downlink data notification. The interface over which the SMF 266 communicates with the AMF 264 is referred to as the N11 interface.

Another optional aspect may include an LMF 270, which may be in communication with the NGC 260 to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, NGC 260, and/or via the Internet (not illustrated).

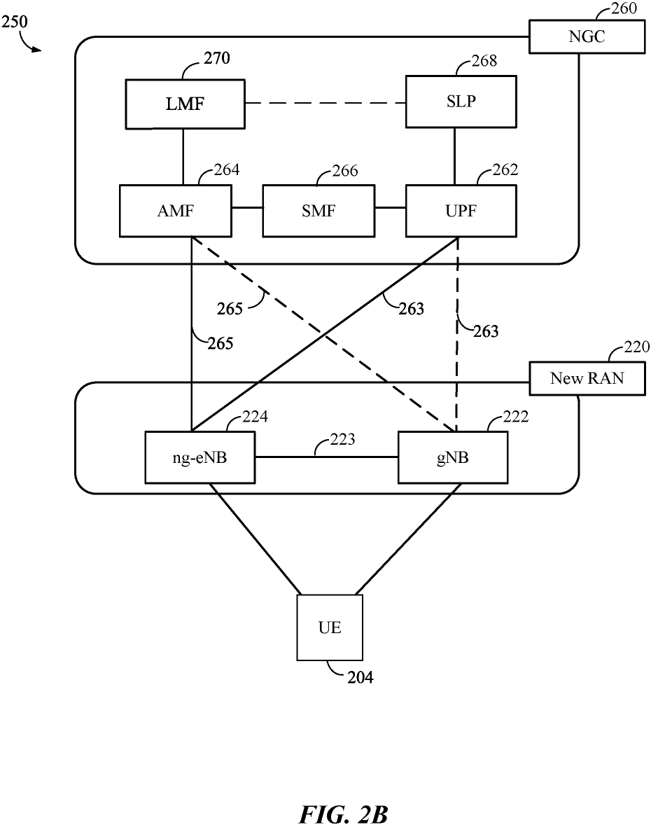

FIG. 3 shows a block diagram of a design 300 of base station 102 and UE 104, which may be one of the base stations and one of the UEs in FIG. 1. Base station 102 may be equipped with T antennas 334a through 334t, and UE 104 may be equipped with R antennas 352a through 352r, where in general T ≥ 1 and R ≥ 1.

At base station 102, a transmit processor 320 may receive data from a data source 312 for one or more UEs, select one or more modulation and coding schemes (MCS) for eachUE based at least in part on channel quality indicators (CQIs) received from the UE, process (e.g., encode and modulate) the data for each UE based at least in part on the MCS(s) selected for the UE, and provide data symbols for all UEs. Transmit processor 320 may also process system information (e.g., for semi-static resource partitioning information (SRPI) and/or the like) and control information (e.g., CQI requests, grants, upper layer signaling, and/or the like) and provide overhead symbols and control symbols. Transmit processor 320 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 330 may perform spatial processing (e.g., precoding) on the data symbols, the control symbols, the overhead symbols, and/or the reference symbols, if applicable, and may provide T output symbol streams to T modulators (MODs) 332a through 332t. Each modulator 332 may process a respective output symbol stream (e.g., for OFDM and/or the like) to obtain an output sample stream. Each modulator 332 may further process (e.g., convert to analog, amplify, filter, and upconvert) the output sample stream to obtain a downlink signal. T downlink signals from modulators 332a through 332t may be transmitted via T antennas 334a through 334t, respectively. According to various aspects described in more detail below, the synchronization signals can be generated with location encoding to convey additional information.

At UE 104, antennas 352a through 352r may receive the downlink signals from base station 102 and/or other base stations and may provide received signals to demodulators (DEMODs) 354a through 354r, respectively. Each demodulator 354 may condition (e.g., filter, amplify, down convert, and digitize) a received signal to obtain input samples. Each demodulator 354 may further process the input samples (e.g., for OFDM and/or the like) to obtain received symbols. A MIMO detector 356 may obtain received symbols from all R demodulators 354a through 354r, perform MIMO detection on the received symbols if applicable, and provide detected symbols. A receive processor 358 may process (e.g., demodulate and decode) the detected symbols, provide decoded data for UE 104 to a data sink 360, and provide decoded control information and system information to a controller/processor 380. A channel processor may determine reference signal received power (RSRP), received signal strength indicator (RSSI), reference signal received quality (RSRQ), channel quality indicator (CQI), and/or the like. In some aspects, one or more components of UE 104 may be included in a housing.

On the uplink, at UE 104, a transmit processor 364 may receive and process data from a data source 362 and control information (e.g., for reports comprising RSRP, RSSI, RSRQ, CQI, and/or the like) from controller/processor 380. Transmit processor 364 may also generate reference symbols for one or more reference signals. The symbols from transmit processor 364 may be precoded by a TX MIMO processor 366 if applicable, further processed by modulators 354a through 354r (e.g., for DFT-s-OFDM, CP-OFDM, and/or the like), and transmitted to base station 102. At base station 102, the uplink signals from UE 104 and other UEs may be received by antennas 334, processed by demodulators 332, detected by a MIMO detector 336 if applicable, and further processed by a receive processor 338 to obtain decoded data and control information sent by UE 104. Receive processor 338 may provide the decoded data to a data sink 339 and the decoded control information to controller/processor 340. Base station 102 may include communication unit 344 and communicate to a location server 172 via communication unit 344. Location server 172 may include communication unit 394, controller/processor 390, and memory 392.

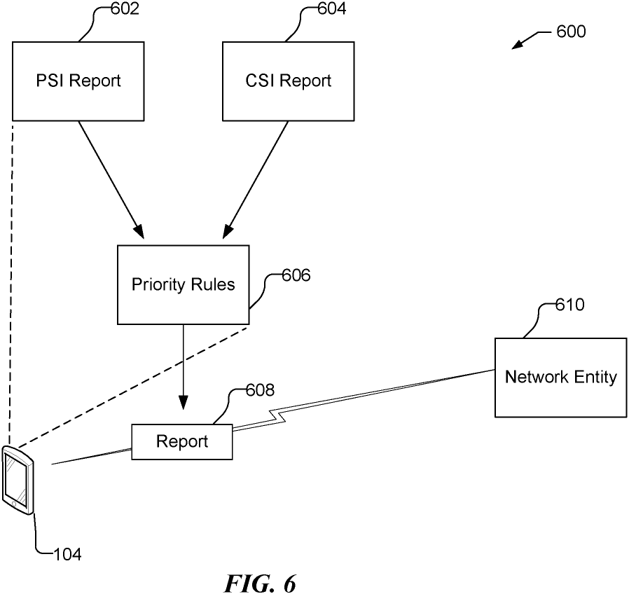

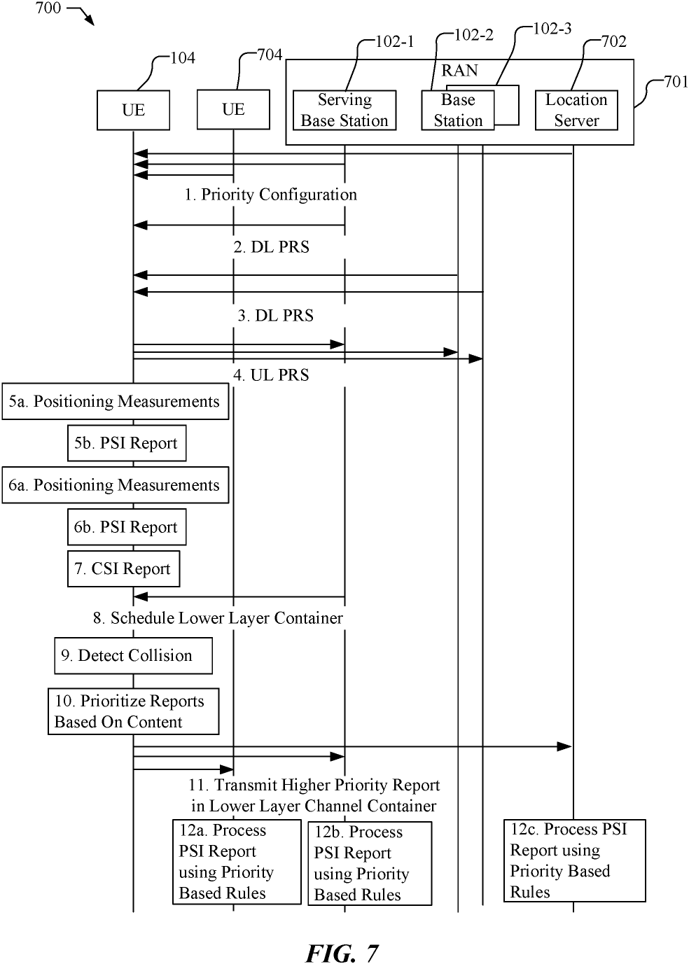

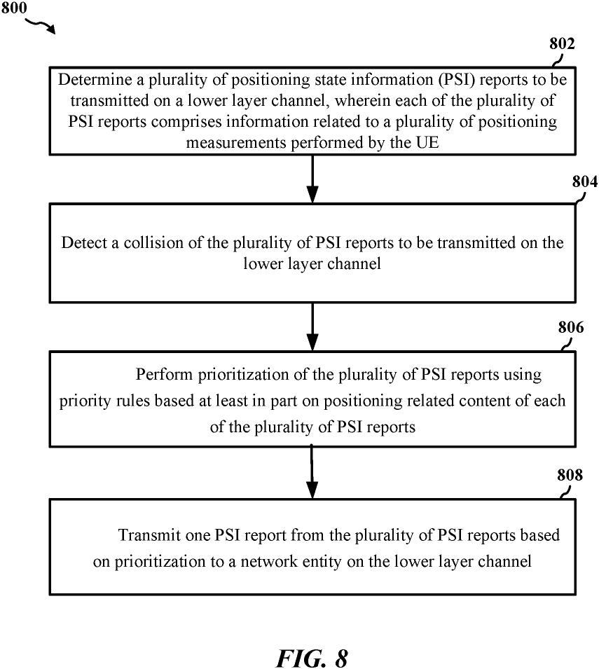

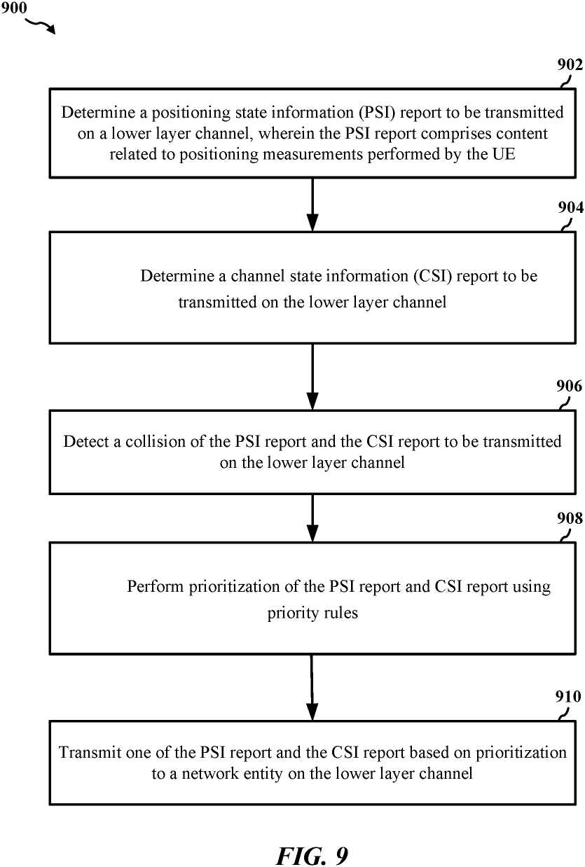

Controller/processor 340 of base station 102, controller/processor 380 of UE 104, controller/processor 390 of the location server 172 and/or any other component(s) of FIG. 3 may perform one or more techniques associated with prioritizing positioning state information (PSI) reports or a PSI report and a channel state information (CSI) report to be transmitted on a lower layer channel, as described in more detail elsewhere herein. For example, controller/processor 340 of base station 102, controller/processor 380 of UE 104, controller/processor 390 of the location server 172 and/or any other component(s) of FIG. 3 may perform or direct operations of, for example, process 700 of FIG. 7, process 800 of FIG. 8, process 900 of FIG. 9, process 1000 of FIG. 10, and/or other processes as described herein. Memories 342, 382, and 392 may store data and program codes for base station 102, UE 104, and location server 172, respectively. In some aspects, memory 342, memory 382, and memory 392 may comprise a non-transitory computer-readable medium storing one or more instructions for wireless communication. For example, the one or more instructions, when executed by one or more processors of the base station 102, the UE 104, or the location server 172 may perform or direct operations of, for example, process 700 of FIG. 7, process 800 of FIG. 8, process 900 of FIG. 9, process 1000 of FIG. 10, and/or other processes as described herein. A scheduler 346 may schedule UEs for data transmission on the downlink and/or uplink.

As indicated above, FIG. 3 is provided as an example. Other examples may differ from what is described with regard to FIG. 3.

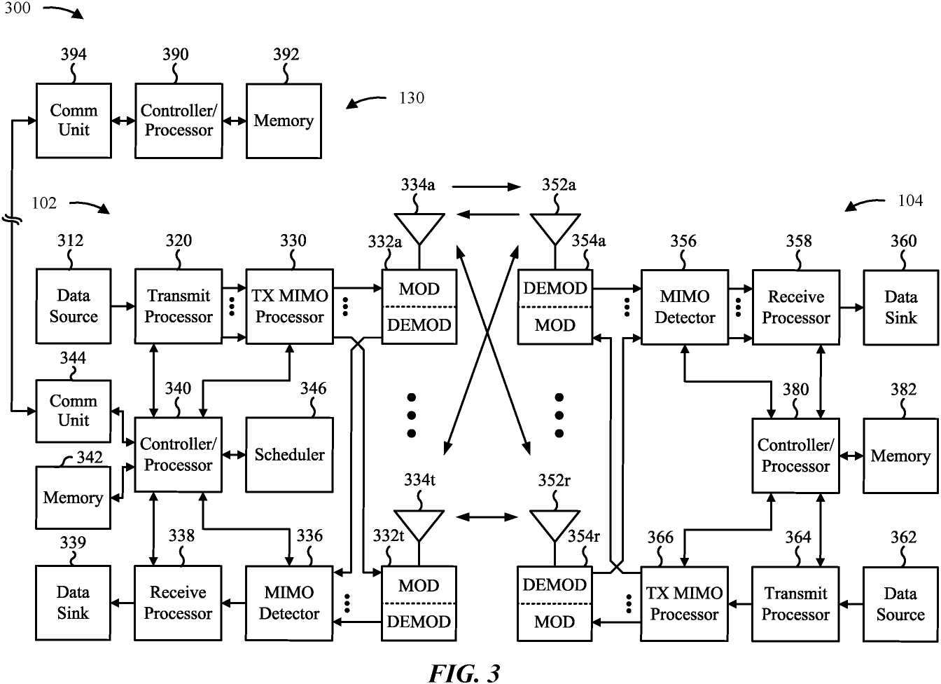

FIG. 4 shows a structure of an exemplary subframe sequence 400 with positioning reference signal (PRS) positioning occasions, according to aspects of the disclosure. Subframe sequence 400 may be applicable to the broadcast of PRS signals from a base station (e.g., any of the base stations described herein) or other network node. The subframe sequence 400 may be used in LTE systems, and the same or similar subframe sequence may be used in other communication technologies / protocols, such as 5G NR. In FIG. 4, time is represented horizontally (e.g., on the X axis) with time increasing from left to right, while frequency is represented vertically (e.g., on the Y axis) with frequency increasing (or decreasing) from bottom to top. As shown in FIG. 4, downlink and uplink radio frames 410 may be of 10 millisecond (ms) duration each. For downlink frequency division duplex (FDD) mode, radio frames 410 are organized, in the illustrated example, into ten subframes 412 of 1 ms duration each. Each subframe 412 comprises two slots 414, each of, for example, 0.5 ms duration.

In the frequency domain, the available bandwidth may be divided into uniformly spaced orthogonal subcarriers 416 (also referred to as “tones” or “bins”). For example, for a normal length cyclic prefix (CP) using, for example, 15 kHz spacing, subcarriers 416 may be grouped into a group of twelve (12) subcarriers. A resource of one OFDM symbol length in the time domain and one subcarrier in the frequency domain (represented as a block of subframe 412) is referred to as a resource element (RE). Each grouping of the 12 subcarriers 416 and the 14 OFDM symbols is termed a resource block (RB) and, in the example above, the number of subcarriers in the resource block may be written as [symbol] = 12. For a given channel bandwidth, the number of available resource blocks on each channel 422, which is also called the transmission bandwidth configuration 422, is indicated as [symbol] . For example, for a 3 MHz channel bandwidth in the above example, the number of available resource blocks on each channel 422 is given by [symbol] = 15. Note that the frequency component of a resource block (e.g., the 12 subcarriers) is referred to as a physical resource block (PRB).

A base station may transmit radio frames (e.g., radio frames 410), or other physical layer signaling sequences, supporting PRS signals (i.e. a downlink (DL) PRS) according to frame configurations either similar to, or the same as that, shown in FIG. 4, which may be measured and used for a UE (e.g., any of the UEs described herein) position estimation. Other types of wireless nodes (e.g., a distributed antenna system (DAS), remote radio head (RRH), UE, AP, etc.) in a wireless communications network may also be configured to transmit PRS signals configured in a manner similar to (or the same as) that depicted in FIG. 4.

A collection of resource elements that are used for transmission of PRS signals is referred to as a “PRS resource.” The collection of resource elements can span multiple PRBs in the frequency domain and N (e.g., 1 or more) consecutive symbol(s) within a slot 414 in the time domain. For example, the cross-hatched resource elements in the slots 414 may be examples of two PRS resources. A “PRS resource set” is a set of PRS resources used for the transmission of PRS signals, where each PRS resource has a PRS resource identifier (ID). In addition, the PRS resources in a PRS resource set are associated with the same transmission-reception point (TRP). A PRS resource ID in a PRS resource set is associated with a single beam transmitted from a single TRP (where a TRP may transmit one or more beams). Note that this does not have any implications on whether the TRPs and beams from which signals are transmitted are known to the UE.

PRS may be transmitted in special positioning subframes that are grouped into positioning occasions. A PRS occasion is one instance of a periodically repeated time window (e.g., consecutive slot(s)) where PRS are expected to be transmitted. Each periodically repeated time window can include a group of one or more consecutive PRS occasions. Each PRS occasion can comprise a number N_{PRS} of consecutive positioning subframes. The PRS positioning occasions for a cell supported by a base station may occur periodically at intervals, denoted by a number T_{PRS} of milliseconds or subframes. As an example, FIG. 4 illustrates a periodicity of positioning occasions where N_{PRS} equals 4 418 and T_{PRS} is greater than or equal to 20 420. In some aspects, T_{PRS} may be measured in terms of the number of subframes between the start of consecutive positioning occasions. Multiple PRS occasions may be associated with the same PRS resource configuration, in which case, each such occasion is referred to as an “occasion of the PRS resource” or the like.

A PRS may be transmitted with a constant power. A PRS can also be transmitted with zero power (i.e., muted). Muting, which turns off a regularly scheduled PRS transmission, may be useful when PRS signals between different cells overlap by occurring at the same or almost the same time. In this case, the PRS signals from some cells may be muted while PRS signals from other cells are transmitted (e.g., at a constant power). Muting may aid signal acquisition and time of arrival (TOA) and reference signal time difference (RSTD) measurement, by UEs, of PRS signals that are not muted (by avoiding interference from PRS signals that have been muted). Muting may be viewed as the non-transmission of a PRS for a given positioning occasion for a particular cell. Muting patterns (also referred to as muting sequences) may be signaled (e.g., using the LTE positioning protocol (LPP)) to a UE using bit strings. For example, in a bit string signaled to indicate a muting pattern, if a bit at position j is set to ‘0’, then the UE may infer that the PRS is muted for a j^{th} positioning occasion.

To further improve hearability of PRS, positioning subframes may be low-interference subframes that are transmitted without user data channels. As a result, in ideally synchronized networks, PRS may be interfered with by other cells’ PRS with the same PRS pattern index (i.e., with the same frequency shift), but not from data transmissions. The frequency shift may be defined as a function of a PRS ID for a cell or other transmission point (TP) (denoted as [symbol] ) or as a function of a physical cell identifier (PCI) (denoted as [symbol] ) if no PRS ID is assigned, which results in an effective frequency re-use factor of six (6).

To also improve hearability of a PRS (e.g., when PRS bandwidth is limited, such as with only six resource blocks corresponding to 1.4 MHz bandwidth), the frequency band for consecutive PRS positioning occasions (or consecutive PRS subframes) may be changed in a known and predictable manner via frequency hopping. In addition, a cell supported by a base station may support more than one PRS configuration, where each PRS configuration may comprise a distinct frequency offset (vshift), a distinct carrier frequency, a distinct bandwidth, a distinct code sequence, and/or a distinct sequence of PRS positioning occasions with a particular number of subframes (N_{PRS}) per positioning occasion and a particular periodicity (T_{PRS}). In some implementation, one or more of the PRS configurations supported in a cell may be for a directional PRS and may then have additional distinct characteristics, such as a distinct direction of transmission, a distinct range of horizontal angles, and/or a distinct range of vertical angles.

A PRS configuration, as described above, including the PRS transmission/muting schedule, is signaled to the UE to enable the UE to perform PRS positioning measurements. The UE is not expected to blindly perform detection of PRS configurations.

Note that the terms “positioning reference signal” and “PRS” may sometimes refer to specific reference signals that are used for positioning in LTE systems. However, as used herein, unless otherwise indicated, the terms “positioning reference signal” and “PRS” refer to any type of reference signal that can be used for positioning, such as but not limited to, PRS signals in LTE, navigation reference signals (NRS), transmitter reference signals (TRS), cell-specific reference signals (CRS), channel state information reference signals (CSI-RS), primary synchronization signals (PSS), secondary synchronization signals (SSS), etc.

Similar to DL PRS transmitted by base stations, discussed above, a UE may transmit UL PRS for positioning. The UL PRS may be, e.g., sounding reference signals (SRS) for positioning. Using received DL PRS from base stations and/or UL PRS transmitted to base stations, the UE may perform various positioning methods, such as time of arrival (TOA), reference signal time difference (RSTD), time difference of arrival (TDOA), time difference of arrival (TDOA), reference signal received power (RSRP), time difference between reception and transmission of signals (Rx-Tx), angle of arrival (AoA), or angle of departure (AoD), etc. In some implementations, the DL PRS and UL PRS are received and transmitted jointly to perform multi-cell positioning measurements, such as multi-Round Trip Time (RTT).

Various positioning technologies rely on DL PRS or UL PRS (or SRS for positioning). For example, positioning technologies that use reference signal include downlink based positioning, uplink based positioning, and combined downlink and uplink based positioning. For example, downlink based positioning includes positioning methods such as DL-TDOA and DL-AoD. Uplink based positioning includes positioning method such as UL-TDOA and UL-AoA. Downlink and uplink based positioning includes positioning method, such as RTT with one or more neighboring base station (multi-RTT). Other positioning methods exist, including methods that do not relay on PRS. For example, Enhanced Cell-ID (E-CID) is based on radio resource management (RRM) measurements.

3GPP Release 16 addresses techniques for positioning with high accuracy, such as using a large bandwidth, beam sweeping in Frequency Range 2 (FR2) that includes frequency bands from 24.25 GHz to 52.6 GHz, angle-based positioning methods such as AoA and AoD, and multi- RTT. Latency, however, is not addressed in depth in Release 16. For example, it is agreed in Release 16 that “UE based positioning,” such as DL based positioning, saves latency. Reporting in Release 16, however, is via LPP or RRC, using mechanisms similar to LTE, and does not provide for low latency reporting. For example, LPP and RRC share physical resources and include redundancies, which is advantageous in many aspects, but inherently increases latency.

Low latency, however, is desirable for positioning. For example, latency less than 100 ms or less than 10 ms in some Industrial Internet of Things (IIoT) cases, may be desirable. In order to reduce latency in positioning, reporting may be performed using lower layer channels, such as layer 1 (L1), which is PHYSICAL (PHY) layer, or layer 2 (L2), which is Medium Access Control (MAC) layer, as opposed to using higher latency LPP or RRC. Lower layer reporting, for example, may be used with on-demand positioning using special physical random access channel (PRACH) sequences. The use of lower layer (L1/L2) reporting to reduce latency is beneficial for communications between the UE 104 and the base station 102. Latency issues between the Latency issues between the UE 104 and the LMF 270 may be addressed using additional mechanisms, such as “LMF in the RAN.” With LMF in the RAN, the location server is within the same Technical Specification Group (TSG) Radio Access Network (RAN). For examples the location server may be an internal function of the NG-RAN node, the location server may be a logical node within the split gNB, or the location server may a logical node in the NG-RAN, connected to NG-RAN nodes (gNBs and/or ng-eNBs) via an interface, such that it can still receive the report from the UE.

Positioning measurements, however, are currently reported through high layer signaling, e.g., via layer 3 (L3), which is RRC or LPP. For example, measurement reports that may be provided through high layer signaling include, e.g., one or multiple TOA, TDOA, RSRP, Rx-Tx, AoA/AoD, multipath reporting (e.g., for ToA, RSRP, AoA/AoD), motion states (e.g., walking, driving, etc.,) and trajectories, and report quality indication.

It may be desirable to report positioning measurements, which are sometimes referred to herein as Positioning State Information (PSI) in a lower layer, e.g., L1/L2, to reduce latency. Positioning State Information may alternatively be referred to as CSI report for positioning, CSI report with positioning measurements, measurement location report, positioning measurement report, positioning information report, location information report, CSI report with location information. When reporting PSI with lower layer signaling, however, it is possible that two or more PSI report transmissions may “collide,” e.g., they may be scheduled to be transmitted simultaneously. For example, a periodic PSI report (or semi-persistent PSI report) may be scheduled to be transmitted simultaneously with an aperiodic PSI report. Further, it is possible that a PSI report may be scheduled to be transmitted simultaneously with a Channel State Information (CSI) report. Where two or more PSI reports collide (or a PSI report collides with a CSI report), the UE may prioritize the PSI reports (or PSI report and CSI report) using one or more priority rules based at least in part on positioning related content of PSI reports.

In NR, CSI may be reported by a UE such that when CSI reports collide, some CIS reports may be dropped or omitted according to a number of prioritization rules. CSI is not related to positioning but provides a mechanism through which a UE reports various measured radio channel quality parameters to a network, e.g., gNB. A CSI reports several different radio channel parameters, such as Channel Quality Indicator (CQI), Pre-coding Matrix Indicator (PMI), Rank Indicator (RI), Layer Indicator (LI), L1-RSRP. The interpretation of some fields may depend on values of other fields and the CSI report consists of a set of fields in a pre-specified order. A single UL transmission, e.g., on physical uplink shared channel (PUSCH) or physical uplink control channel (PUCCH) may contain multiple reports that are arranged according to a priority, e.g., as defined 3GPP TS 38.214, which may depend on report periodicity, e.g., aperiodic, semi-persistent, periodic over PUSCH/PUCCH; type, e.g., L1-RSRP or not; serving-cell index, e.g., in a carrier aggregation case, and reportconfigID.

CSI may be reported in two parts, e.g., 2-part CSI reporting. With 2-part CSI presorting, the first part (part1) of all reports are collected together and the second part (part2) are separately collected, and each collection is separately encoded. The part 1 payload size is based on configuration parameters, while the part2 payload size depends on configuration and on the part1 contents. The number of coded bits/symbols to be output after encoding and rate matching is computed based on number of input bits and beta factors, e.g., defined in 3GPP TS 38.212. Further, linkages are defined between instances of resource sets (RS) being measured and corresponding reporting.

Two or more CSI report transmissions may “collide”, in the sense that they are scheduled to be transmitted simultaneously (for instance in a periodic transmission and an aperiodic transmission). It may also occur that that a number of CSI reports scheduled to be transmitted simultaneously result in too large payload size cannot fit in the Uplink Control Information (UCI) container (for instance due to Hybrid Automatic Repeat ReQuest acknowledgement (HARQ-ACK) and/or Scheduling Request (SR) additionally needs to be multiplexed). In a situation in which CSI reports collide, some CSI reports may be dropped or omitted, based on a number of defined prioritization rules.

For example, CSI reports may be first prioritized according to their time-domain behavior and physical channel, e.g., where more dynamic reports are given precedence over less dynamic reports and PUSCH has precedence over PUCCH. Thus, an aperiodic CSI report has priority over a semi-persistent CSI report on PUSCH, which in turn has priority over a semi-persistent report on PUCCH, which has priority over a periodic CSI report.

If multiple CSI reports with the same time-domain behavior and physical channel collide, the CSI reports may be further prioritized depending on whether the CSI carries beam reports, i.e., L1-RSRP reporting, where beam reporting has priority over regular CSI reports. The motivation for prioritizing beam reports, for example, is that the CSI report is typically conditioned on a serving beam, so if the beam is not correct the CSI report is useless anyway.

If further differentiation is required, the CSI reports may be further prioritized based on for which serving cell the CSI corresponds (in case of carrier aggregation (CA) operation). In other words, CSI corresponding to the primary cell (PCell) has priority over CSI corresponding to second cells (Scells).

Finally, in order to avoid any ambiguities as to which CSI report is to be transmitted, the CSI reports may be prioritized based on the reportConfigID.

With the application of the above priority rules, only a single CSI report is transmitted in case of CSI collision, with the exception of multiple PUCCH-based CSI reports colliding. If multiple PUCCH-based CSI reports collide, it is possible to configure the UE with a larger “multi-CSI” PUCCH resource, where several CSI reports can be multiplexed in case of collision. In this case, as many PUCCH-based CSI reports are transmitted in the “multi-CSI” PUCCH resource as possible without exceeding a maximum UCI code rate.

The prioritization rules for CSI collisions is defined, e.g., in 3GPP Technical Specification (TS) 38.214, which states the following. CSI reports are associated with a priority value Priᵢ_{CSI}(y,k,c,s) = 2 · N_{cells} · Mₛ · y + N_{cells} · Mₛ ·k + Mₛ · c + s where
y=0 for aperiodic CSI reports to be carried on PUSCH y=1 for semi-persistent CSI reports to be carried on PUSCH, y=2 for semi-persistent CSI reports to be carried on PUCCH and y=3 for periodic CSI reports to be carried on PUCCH;
k=0 for CSI reports carrying L1-RSRP and k=1 for CSI reports not carrying L1-RSRP;
c is the serving cell index and N_{cells} is the value of the higher layer parameter maxNrofServingCells;
s is the reportConfigID and Mₛ is the value of the higher layer parameter maxNrofCSI-ReportConfigurations.

A first CSI report is said to have priority over second CSI report if the associated Pri_{iCSI}(y, k, c, s) value is lower for the first report than the second report.

Positioning state information (PSI) is different than CSI, as the type of information for positioning measurements included in a PSI report may vary greatly depending on the type of positioning measurement performed, the number of positioning measurements, the type of positioning method being supported, etc.

As discussed above, it may be desirable to report PSI on a lower layer (L1/L2) uplink channel, e.g., on a physical layer (PUSCH or PUCCH), on a MAC layer (Medium Access Control - Control Element (MAC-CE) block), or a physical sidelink shared control channel (PSSCH). Two or more PSI report transmissions may collide, e.g., they may be scheduled to be transmitted simultaneously. Where two or more PSI reports collide, the UE 104 may prioritize the PSI reports using one or more priority rules based at least in part on positioning related content of PSI reports, where the higher priority PSI report is transmitted and the remaining PSI reports are dropped, i.e., are not transmitted.

Prioritization of colliding PSI reports may use priority rules based at least in part on positioning related content of PSI reports, such as in one or more of the following examples.

Rule 1: A PSI report carrying timing measurements has priority over those having only energy measurements. For example, a PSI report carrying timing measurements, such as RSTD or Rx-Tx, has priority over a PSI report carrying an energy measurement such as RSRP.

Rule 2: A PSI report carrying first-arrival measurements has priority over those carrying multipath measurements. For example, a PSI report that includes first arrival measurements for, e.g., RSTD, UE Rx-Tx, RSRP, has priority over a PSI report carrying multi-path reporting, such as the difference between second path positioning measurement with respect to the first arrival positioning measurement.

Rule 3: In an TDOA positioning session, a PSI report carrying RSTD measurements has priority over a PSI report carrying RSRP measurements.

Rule 4: In a multi-RTT positioning session, a PSI report carrying Rx-Tx measurements for has priority over a PSI report carrying RSRP measurements.

Rule 5: In an AoD positioning session, a PSI report carrying RSTD measurements has priority over a PSI report carrying timing measurements.

Rule 6: A PSI report carrying multiple measurement types (e.g., RSTD and Rx-Tx) has priority over a PSI report carrying only a single measurement type (e.g., only RSTD).

Rule 7: A PSI report carrying positioning measurements of the reference TRP has priority over a PSI report carrying measurements of only neighboring TRPs.

Rule 8: A PSI report carrying velocity information has lower priority than a PSI report carrying timing or energy positioning measurements (e.g., RSTD, Rx-Tx, RSRP).

Rule 9: A PSI report carrying positioning measurements derived from a DL PRS or UL PRS has priority over a PSI report carrying positioning measurements derived from non-PRS signals, such as a synchronization signal block (SSB), or tracking reference signal (TRS), or physical random access channel (PRACH) signal.

Rule 10: A PSI report containing one or more positioning fixes has priority over PSI reports that contain positioning measurements (e.g., RSTD, RSRP, Rx-Tx, TOA, etc.).

Rule 11: A PSI report with the latest timestamp has priority over those with earlier timestamps.

Rule 12: A PSI report containing positioning measurements derived from an intra-frequency measurement has priority over those containing positioning measurements derived from inter-frequency measurements, wherein intra-frequency measurements comprise measurements performed on the same positioning frequency layer and inter-frequency measurements comprise measurements performed across at least two different positioning frequency layers.

In some implementations, the PSI reports may also be prioritized using one or more priority rules based on non-positioning related content, such as one or more of the CSI priority rules discussed above. An example, of priority rules based on non-positioning related content is prioritizing two or more colliding PSI reports according to their time-domain behavior and physical channel, e.g., where more dynamic reports are given precedence over less dynamic reports and PUSCH has precedence over PUCCH. For example, an aperiodic PSI report may have priority over a semi-persistent PSI report on PUSCH, which in turn may have priority over a semi-persistent PSI report on PUCCH, which may priority over a periodic PSI report. For example, PSI reports may be prioritized first based on their time-domain behavior and physical channel, and then further prioritized based on priority rules related to positioning related content, as discussed below.

To further differentiate PSI reports, e.g., if a PSI report does not have higher priority based on time-domain behavior and physical channel or positioning related content, the PSI reports may be further prioritized based on for which serving cell the PSI corresponds (in case of carrier aggregation (CA) operation). Thus, PSI corresponding to the primary cell (PCell) has priority over PSI corresponding to second cells (Scells).

Finally, in order to avoid any ambiguities as to which PSI report is to be transmitted, the PSI reports may be prioritized based on the associated identifiers, e.g., reportConfigID.

A PSI report may also collide with a CSI report. If a PSI and CSI report collide, the UE 104 may prioritize the reports using a set of one or more priority rules, e.g., where the higher priority CSI report or PSI report is transmitted and the remaining report is dropped, i.e., not transmitted. In some implementations, the priority rules may be based, at least in part, on the positioning related content of the PSI report. Prioritization of colliding PSI and CSI reports may use priority rules based at least in part on positioning related content of PSI reports, such as in the following examples.

Rule 13: A CSI report has priority over a PSI including positioning information report regardless of type of positioning information in the PSI report.

Rule 14: A PSI report that includes one or more positioning fixes has priority over the CSI report.

In some implementations, the PSI and CSI reports may also be prioritized using one or more priority rules based on non-positioning related content, such as one or more of the CSI priority rules discussed above. For example, if a PSI report and a CSI report collide, the UE may prioritize according to their time-domain behavior and physical channel, e.g., where more dynamic reports are given precedence over less dynamic reports and PUSCH has precedence over PUCCH. For example, an aperiodic report has priority over a semi-persistent report on PUSCH, which in turn has priority over a semi-persistent report on PUCCH, which has priority over a periodic report.

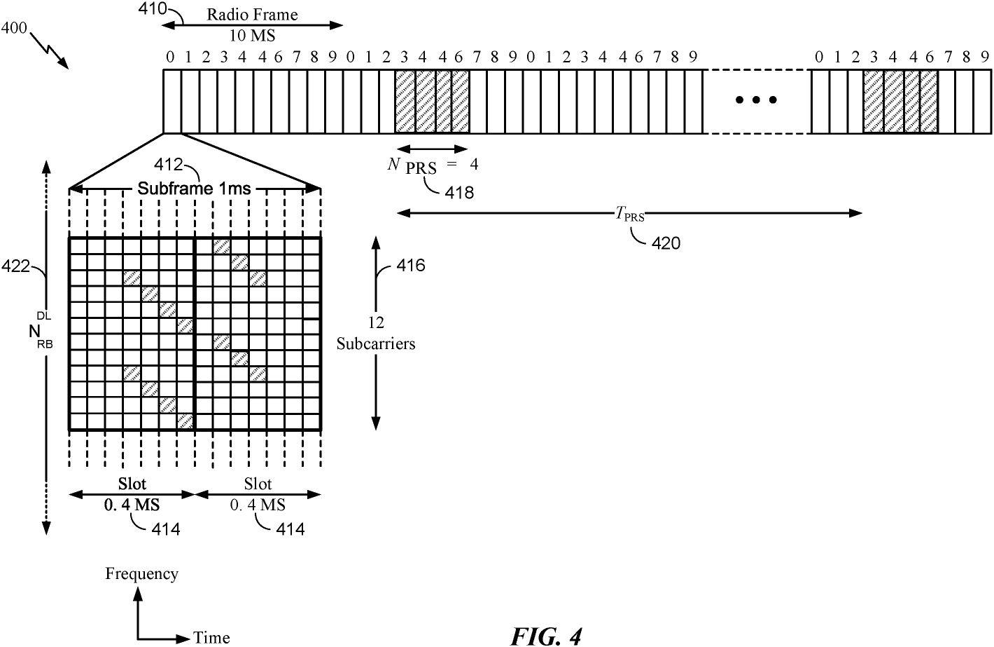

FIG. 5 is a block diagram 500 illustrating a UE 104 configured to prioritize colliding PSI reports based at least in part on positioning related content and to transmit the higher priority PSI report on a lower layer channel to a network entity 510, according to one aspect of the present disclosure. As illustrated, the UE 104 may determine a plurality of PSI reports, illustrated as PSI reports 502 and 504, which collide, e.g., are scheduled to be transmitted simultaneously. Each PSI report, for example, includes information related to positioning measurements performed by the UE. As discussed above, priority rules 506 are applied to the plurality of PSI reports 502 and 504. The priority rules 506 may be based at least in part on positioning related content of the PSI reports, by way of example and not limitation, such as one or more of the rules 1-12 discussed above. In some implementations, the priority rules 506 may include non-positioning content related rules, such as prioritizing according to time-domain behavior and physical channel before prioritizing based on positioning related content, or prioritizing based which serving cell the PSI report corresponds or based on the associated identifiers if the positioning related content is the same. Based on the priority rules 506, the higher priority PSI report is transmitted from the UE 104 to the network entity 510, as illustrated by PSI report 508, in a lower layer channel container, e.g., a PUSCH, PUCCH, or PSSCH, or in a MAC-CE block. The PSI report 508 corresponds to the one of the PSI reports 502 and 504 with the higher priority. The lower priority PSI report is dropped, e.g., not transmitted to the network entity 510. The network entity 510 that receives the PSI report 508 may be, e.g., a base station, such as base station 102 or a location server such as location server 172 or LMF 270, or a sidelink UE.

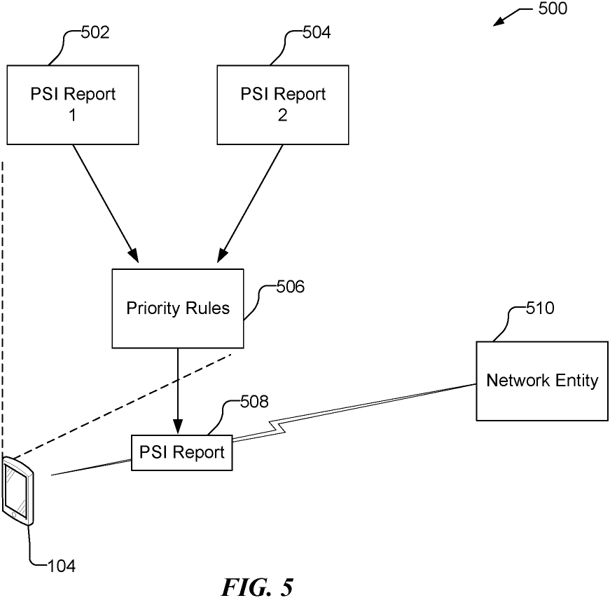

FIG. 6 is a block diagram 600 illustrating a UE 104 configured to prioritize a colliding PSI report and CSI report based at least in part on positioning related content and to transmit the higher priority report on a lower layer channel to a network entity 610, according to one aspect of the present disclosure. As illustrated, the UE 104 may determine a PSI report 602 and a CSI report 604, which collide, e.g., are scheduled to be transmitted simultaneously. As discussed above, priority rules 606 are applied to the PSI report 602 and CSI report 604. The priority rules 606 may be based at least in part on positioning related content of the PSI reports, by way of example, and not limitation, such as rules 13-14 discussed above. In some implementations, the priority rules 606 may include non-positioning content related rules, such as prioritizing according to time-domain behavior and physical channel. Based on the priority rules 606, the higher priority report is transmitted from the UE 104 to the network entity 610, as illustrated by report 608, in a lower layer channel container, e.g., a PUSCH, PUCCH, or PSSCH, or in a MAC-CE block. The report 608 corresponds to the one of the PSI report 602 or CSI report 604 with the higher priority. The lower priority report is dropped, e.g., not transmitted to the network entity 610. The network entity 610 that receives the report 608 may be, e.g., a base station, such as base station 102 or a location server such as location server 172 or LMF 270, or a sidelink UE.

FIG. 7 is a message flow 700 with various messages sent between components of the communication system 100 depicted in FIG. 1, illustrating the prioritization of colliding PSI reports based at least in part on positioning related content and to transmitting the higher priority report on a lower layer channel to a network entity, according to one aspect of the present disclosure. Location server 702 may be, e.g., location server 172 shown in FIG. 1 or LMF 270 shown in FIG. 2. The serving base station 102-1 and other base stations 102-2, 102-3 are sometimes collectively referred to as base stations 102. UE 704 may be a UE that is in sidelink communication with the UE 104. The UE 104 may be configured to perform UE assisted positioning or UE based positioning, using downlink based positioning, uplink based positioning or combined downlink and uplink based positioning. In the message flow 700, it is assumed, unless otherwise stated, that the UE 104 and location server 702 may communicate using lower layer channels as well as other mechanisms, such as LMF in the RAN, as discussed above, to reduce latency. For example, the location server 702 may be within the RAN 701, e.g., as an internal function of an NG-RAN node, such as serving base station 102-1, the location server 702 may be a logical node within the split gNB, e.g., serving base station 102-1, or the location server may be a logical node in the NG-RAN 701, connected to NG-RAN nodes, e.g., serving base station 102-1 and neighboring base stations 102-2 and 102-3 via an interface, such that it can still receive the report from the UE. It should be understood that preliminary or additional conventional stages not shown in FIG. 7 may be performed, such as capability requests and responses, requests for and providing assistance data, etc.

At stage 1, the UE 104 may receive a configuration for prioritization of colliding PRSI reports. The configuration, e.g., may be provided by either serving base station 102-1, the location server 702, or the sidelink UE 704.

At stage 2 and stage 3, the UE 104 receives DL PRS from serving base station 102-1 and neighboring base stations 102-2 and 102-3.

At stage 4, the UE 104 may optionally transmit UL PRS or SRS for positioning, to the base stations 102.

At stage 5a, the UE 104 may perform DL positioning measurements for one or more positioning methods based on the DL PRS received at stages 2 and 3, UL positioning measurements for one or more positioning methods based on the UL PRS transmitted at stage 4, or DL and UL positioning measurements for one or more positioning methods based on the DL PRS received at stages 2 and 3 and the UL PRS transmitted at stage 4. In some implementations, the UE 104 may perform multiple positioning measurements, e.g., the same type of positioning measurements at different times and/or different types of positioning measurements at the same time or at different times. By way of example, the positioning information obtained by UE 104 from the positioning measurements include one or more of, timing measurements such as RSTD, UE Rx-Tx, TOA, etc., energy measurements such as RSRP, quality metrics, velocity and/or trajectory measurements, reference TRP, multipath information, LOS/NLOS factors, SINR, and time stamps. The positioning measurements may be for one or more positioning methods for which the UE 104 is configured, such as TDOA, AoD, multi-RTT, hybrid positioning methods, etc. The positioning measurement may further include determining a positioning fix for the UE 104 in a UE based positioning process using the position measurements and the locations of base stations, e.g., received in assistance data.

At stage 5b, the UE 104 generates a PSI report based on the positioning measurements from stage 5a.

At stage 6a, similar to stage 5a, the UE 104 may perform positioning measurements for one or more positioning methods based on the DL PRS received at stages 2 and 3, UL positioning measurements for one or more positioning methods based on the UL PRS transmitted at stage 4, or DL and UL positioning measurements for one or more positioning methods based on the DL PRS received at stages 2 and 3 and the UL PRS transmitted at stage 4. In some implementations, the positioning measurements may be based on a different set of DL PRS and/or UL PRS than that shown at stages 2-4. The positioning measurement may further include determining a positioning fix for the UE 104 in a UE based positioning process using the position measurements and the locations of base stations, e.g., received in assistance data. The positioning measurements performed in stage 6a may be performed at the same time, e.g., using the same DL PRS and/or UL PRS as the positioning measurements performed in stage 5a, or may be performed at a different time using a different set of DL PRS and/or UL PRS. Further, the positioning measurements performed in stage 6a may be the same type of positioning measurements or a different type of positioning measurements as performed in stage 6b. The positioning measurements performed in stage 6a may be for the same type of positioning method or a different type of positioning method as performed in stage 6b. The positioning measurements performed in stage 6a may be performed using one or more different base stations 102 and/or frequencies bands than used for the positioning measurements performed in stage 5a.

At stage 6b, the UE 104 generates a PSI report based on the positioning measurements from stage 6a.

At stage 7, the UE 104 may generate a CSI report, e.g. to report measured radio channel quality parameters, such as CQI, PMI, RI, LI, L1-RSRP.

At stage 8, the UE 104 may receive, e.g., from the serving base station 102-1 a schedule or grant for a lower layer container in which a PSI report or CSI report is to be transmitted by the UE 105.

At stage 9, the UE 104 detects a collision between one or more of the PSI reports from stages 5b and 6b and the CSI report from stage 7. In other words, the UE 104 determines that the one or more of the PSI reports from stages 5b and 6b and the CSI report from stage 7 are scheduled to be transmitted simultaneously, e.g., in the same lower layer channel container. For example, the UE 104 may determine that the PSI reports from stages 5b and 6b collide or that one or both of the PSI reports and the CSI report from stage 7 collide.

At stage 10, the UE 104 prioritizes the PSI reports and the CSI report using priority rules that are at least partially based on positioning related content. The priority rules may be configured from stage 1 or the UE 104 may configure the priority rules. For example, colliding PSI reports may be prioritized using priority rules that are based, at least in part, on the positioning related content, such as one or more of rules 1-12 discussed above, or other positioning related priority rules. In some implementations, for colliding PSI reports, the priority rules may include non-positioning content related rules, such as prioritizing according to time-domain behavior and physical channel before prioritizing based on positioning related content, or prioritizing based which serving cell the PSI report corresponds or based on the associated identifiers if the positioning related content is the same. In another example, one or more PSI reports colliding with a CSI report may be prioritized using priority rules that are based, at least in part, on the positioning related content, such as one or more of rules 13-14 discussed above, or other priority rule. In some implementations, for colliding PSI and CSI reports, the priority rules may include non-positioning content related rules, such as prioritizing according to time-domain behavior and physical channel before prioritizing based on positioning related content.

At stage 11, the UE 104 transmits the higher priority report in a lower layer channel container, e.g., to the sidelink UE 704, the serving base station 102 or the location server 702 on an uplink. For example, the UE 104 may transmit a higher priority PSI report using a PHY layer, e.g., using PUSCH, PUCCH, PSSCH, or on a MAC layer, using a MAC-CE block. The lower priority reports may be omitted from the transmission. In some implementations, the transmitted report may include an indication that a PSI report (or CSI report) is omitted from the transmission. Additionally, in instances where the UE 104 determines the configuration for the priority rules, the transmitted report may include the priority rules configuration. Transmission of the PSI report on the lower layer channel, advantageously reduces latency compared to transmission, e.g. on an RRC channel.

At one of stage 12a, stage 12b, and stage 12c, the higher priority PSI report is processed, e.g., by the sidelink UE 704, the serving base station 102-1 or the location server 702, respectively, using the priority based rules. In some implementations, the sidelink UE 704 may forward the PSI report to one of serving base station 102-1 or the location server 702 for processing.

FIG. 8 shows a flowchart for an exemplary method 800 for wireless communications for a UE, such as UE 104, performed by the UE in a manner consistent with disclosed implementation.

At block 802, the UE determines a plurality of positioning state information (PSI) reports to be transmitted on a lower layer channel, wherein each of the plurality of PSI reports comprises information related to a plurality of positioning measurements performed by the UE, such as illustrated in stages 5a/5b and 6a/6b in FIG. 7. At block 804, a collision of the plurality of PSI reports to be transmitted on the lower layer channel is detected, such as illustrated in stage 9 of FIG. 7. At block 806, prioritization of the plurality of PSI reports is performed using one or more priority rules based at least in part on positioning related content of each of the plurality of PSI reports, such as illustrated in stage 10 of FIG. 7 and example rules 1-12 discussed above. At block 808, one PSI report from the plurality of PSI reports is transmitted based on prioritization to a network entity on the lower layer channel, such as illustrated in stage 11 of FIG. 7.

In one implementation, the lower layer channel may be either a Physical layer channel or a Medium Access Control (MAC) layer channel. For example, the physical layer channel may be a physical uplink shared channel (PUSCH), a physical uplink control channel (PUCCH), or a physical sidelink shared channel (PSSCH), and the MAC layer channel may be a MAC - control element (MAC-CE).

In one implementation, the one PSI report from the plurality of PSI reports is transmitted based on prioritization comprises not transmitting remaining PSI reports in the plurality of PSI reports.

In one implementation, the one or more priority rules based at least in part on the positioning related content may include prioritizing a PSI report carrying a first type of positioning measurement over a PSI report carrying a second type of positioning measurements.

In one implementation, the one or more priority rules based at least in part on the positioning related content may include prioritizing a PSI report carrying a timing measurement over a PSI report carrying only energy measurements.

In one implementation, the one or more priority rules based at least in part on the positioning related content may include prioritizing a PSI report carrying first-arrival measurements over a PSI report carrying multipath measurements.

In one implementation, the one or more priority rules based at least in part on the positioning related content may include prioritizing a PSI report carrying Reference Signal Time Difference (RSTD) measurements from an Time Difference of Arrival (TDOA) positioning session over a PSI report carrying Reference Signal Receive Power (RSRP) from the TDOA positioning session.

In one implementation, the one or more priority rules based at least in part on the positioning related content may include prioritizing a PSI report carrying receive-transmit time difference (Rx-Tx) measurements from a multi-Round Trip Time (RTT) positioning session over a PSI report carrying Reference Signal Receive Power (RSRP) from the multi-RTT positioning session.

In one implementation, the one or more priority rules based at least in part on the positioning related content may include prioritizing a PSI report carrying Reference Signal Receive Power (RSRP) measurements from an Angle of Departure (AOD) positioning session over a PSI report carrying timing measurements from the AOD positioning session.

In one implementation, the one or more priority rules based at least in part on the positioning related content may include prioritizing a PSI report carrying multiple types of positioning measurement over a PSI report carrying a single type of positioning measurement.

In one implementation, the one or more priority rules based at least in part on the positioning related content may include prioritizing a PSI report carrying positioning measurements from a reference Transmission Reception Point (TRP) over a PSI report carrying positioning measurement from only one or more neighboring TRPs.

In one implementation, the one or more priority rules based at least in part on the positioning related content may include prioritizing a PSI report carrying timing or energy positioning measurement over a PSI report carrying velocity information.

In one implementation, the one or more priority rules based at least in part on the positioning related content may include prioritizing a PSI report carrying positioning measurements derived from a downlink (DL) or uplink (UL) positioning reference signals (PRS) over a PSI report carrying positioning measurements derived from non-PRS signals.

In one implementation, the one or more priority rules based at least in part on the positioning related content may include prioritizing a PSI report carrying one or more positioning fixes for the UE over a PSI report carrying positioning measurements.

In one implementation, the one or more priority rules based at least in part on the positioning related content may include prioritizing a PSI report carrying a latest timestamp over a PSI report carrying an earlier timestamp.

In one implementation, the one or more priority rules based at least in part on the positioning related content may include prioritizing a PSI report carrying positioning measurements derived from an intra-frequency measurement over a PSI report carrying positioning measurements derived from inter-frequency measurements, wherein intra-frequency measurements comprise measurements performed on the same positioning frequency layer and inter-frequency measurements comprise measurements performed across at least two different positioning frequency layers.

FIG. 9 shows a flowchart for an exemplary method 900 for wireless communications for a UE, such as UE 104, performed by the UE in a manner consistent with disclosed implementation.

At block 902, the UE determines determine a positioning state information (PSI) report to be transmitted on a lower layer channel, wherein the PSI report comprises content related to positioning measurements performed by the UE, such as illustrated in stages 5a/5b and/or 6a/6b in FIG. 7. At block 904, a channel state information (CSI) report to be transmitted on the lower layer channel is determined, such as illustrated in stage 7 of FIG. 7. At block 906, a collision of the PSI report and the CSI report to be transmitted on the lower layer channel is detected, such as illustrated in stage 9 of FIG. 7. At block 908, prioritization of the PSI report and CSI report is performed using one or more priority rules, such as illustrated in stage 10 of FIG. 7. At block 910, one of the PSI report and the CSI report is transmitted based on prioritization to a network entity on the lower layer channel, such as illustrated in stage 11 of FIG. 7.

In one implementation, the lower layer channel may be either a Physical layer channel or a Medium Access Control (MAC) layer channel. For example, the physical layer channel may be either a physical uplink shared channel (PUSCH), a physical uplink control channel (PUCCH), or a physical sidelink shared channel (PSSCH), and the MAC layer channel may be a MAC - control element (MAC-CE).

In one implementation, the one of the PSI report and the CSI report is transmitted based on prioritization includes not transmitting a remaining one of the PSI report and the CSI report.

In one implementation, prioritization of the PSI report and CSI report is performed using one or more priority rules may include prioritizing the CSI report over the PSI report regardless of the content of the PSI report.

In one implementation, prioritization of the PSI report and CSI report is performed using one or more priority rules may include prioritizing the PSI report over the CSI report when the content of the PSI report includes a positioning fix of the UE.

FIG. 10 shows a flowchart for an exemplary method 1000 for wireless communications for a UE, such as UE 104, performed by network entity in a wireless network in a manner consistent with disclosed implementation.

At block 1002, the network entity receives from the UE a positioning state information (PSI) report in a lower layer channel, the PSI report comprising information related to positioning measurements performed by the UE, wherein the PSI report was prioritized over a second colliding PSI report using one or more priority rules based at least in part on positioning related content of the PSI report and the second colliding PSI report, such as illustrated in stage 11 of FIG. 7. At block 1004, the PSI report is processed, as illustrated at stages 9a or 9b in FIG. 7.

In one implementation, the network entity may transmit a prioritization configuration of the priority rules based on positioning related content to the UE, wherein the PSI report was prioritized over the second colliding PSI report based on the prioritization configuration of the priority rules, as illustrated at stages 1 and 10 of FIG. 7.

In one implementation, the network entity may be one of a location server, a serving base station, or a sidelink UE.

In one implementation, the lower layer channel may be either a Physical layer channel or a Medium Access Control (MAC) layer channel. For example, the physical layer channel may be either a physical uplink shared channel (PUSCH), a physical uplink control channel (PUCCH), or a physical sidelink shared channel (PSSCH), and the MAC layer channel may be a MAC - control element (MAC-CE).

In one implementation, the second colliding PSI report is not received from the UE.

In one implementation, the one or more priority rules based at least in part on the positioning related content may be prioritizing a PSI report carrying a first type of positioning measurement over a PSI report carrying a second type of positioning measurements.

In one implementation, the one or more priority rules based at least in part on the positioning related content may be prioritizing a PSI report carrying a timing measurement over a PSI report carrying only energy measurements.

In one implementation, the one or more priority rules based at least in part on the positioning related content may be prioritizing a PSI report carrying first-arrival measurements over a PSI report carrying multipath measurements.

In one implementation, the one or more priority rules based at least in part on the positioning related content may be prioritizing a PSI report carrying Reference Signal Time Difference (RSTD) measurements from an Time Difference of Arrival (TDOA) positioning session over a PSI report carrying Reference Signal Receive Power (RSRP) from the TDOA positioning session.

In one implementation, the one or more priority rules based at least in part on the positioning related content may be prioritizing a PSI report carrying receive-transmit time difference (Rx-Tx) measurements from a multi-Round Trip Time (RTT) positioning session over a PSI report carrying Reference Signal Receive Power (RSRP) from the multi-RTT positioning session.

In one implementation, the one or more priority rules based at least in part on the positioning related content may be prioritizing a PSI report carrying Reference Signal Receive Power (RSRP) measurements from an Angle of Departure (AOD) positioning session over a PSI report carrying timing measurements from the AOD positioning session.

In one implementation, the one or more priority rules based at least in part on the positioning related content may be prioritizing a PSI report carrying multiple types of positioning measurement over a PSI report carrying a single type of positioning measurement.

In one implementation, the one or more priority rules based at least in part on the positioning related content may be prioritizing a PSI report carrying positioning measurements from a reference Transmission Reception Point (TRP) over a PSI report carrying positioning measurement from only one or more neighboring TRPs.

In one implementation, the one or more priority rules based at least in part on the positioning related content may be prioritizing a PSI report carrying timing or energy positioning measurement over a PSI report carrying velocity information.

In one implementation, the one or more priority rules based at least in part on the positioning related content may be prioritizing a PSI report carrying positioning measurements derived from a downlink (DL) or uplink (UL) positioning reference signals (PRS) over a PSI report carrying positioning measurements derived from non-PRS signals.

In one implementation, the one or more priority rules based at least in part on the positioning related content may be prioritizing a PSI report carrying one or more positioning fixes for the UE over a PSI report carrying positioning measurements.

In one implementation, the one or more priority rules based at least in part on the positioning related content may be prioritizing a PSI report carrying a latest timestamp over a PSI report carrying an earlier timestamp.

In one implementation, the one or more priority rules based at least in part on the positioning related content may be prioritizing a PSI report carrying positioning measurements derived from on intra-frequency measurement over a PSI report carrying positioning measurements derived from inter-frequency measurements, wherein intra-frequency measurements comprise measurements performed on the same positioning frequency layer and inter-frequency measurements comprise measurements performed across at least two different positioning frequency layers.

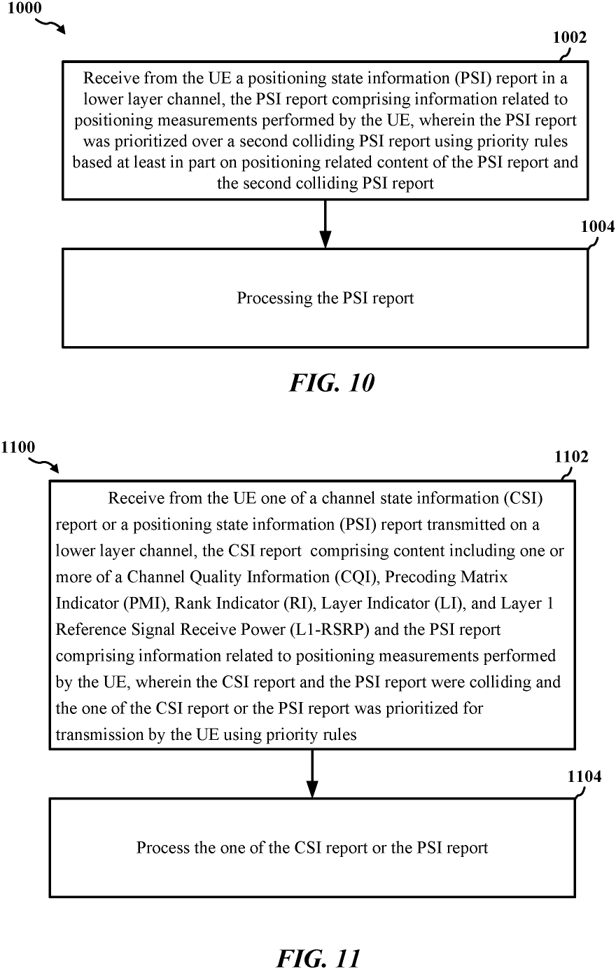

FIG. 11 shows a flowchart for an exemplary method 1100 for wireless communications for a UE, such as UE 104, performed by network entity in a wireless network in a manner consistent with disclosed implementation.

At block 1102, the network entity may receive from the UE one of a channel state information (CSI) report or a positioning state information (PSI) report transmitted on a lower layer channel, the CSI report comprising content including one or more of a Channel Quality Information (CQI), Precoding Matrix Indicator (PMI), Rank Indicator (RI), Layer Indicator (LI), and Layer 1 Reference Signal Receive Power (L1-RSRP) and the PSI report comprising information related to positioning measurements performed by the UE, wherein the CSI report and the PSI report were colliding and the one of the CSI report or the PSI report was prioritized for transmission by the UE using one or more priority rules, such as illustrated in stage 11 of FIG. 7. At block 1104, the one of the CSI report or the PSI report that is received is processed.

In one implementation, the network entity may further transmit a prioritization configuration of the priority rules to the UE, wherein the one of the CSI report or the PSI report was prioritized based on the prioritization configuration of the priority rules, such as illustrated at stages 1 and 10 of FIG. 7.

In one implementation, the network entity may be one of a location server, a serving base station, or a sidelink UE.

In one implementation, the lower layer channel may be either a Physical layer channel or a Medium Access Control (MAC) layer channel. For example, the physical layer channel may be either a physical uplink shared channel (PUSCH), a physical uplink control channel (PUCCH), or a physical sidelink shared channel (PSSCH), and the MAC layer channel may be a MAC - control element (MAC-CE).

In one implementation, the network entity does not receive a remaining one of the PSI report and the CSI report.

In one implementation, the one or more priority rules may be prioritizing the CSI report over the PSI report regardless of the content of the PSI report.

In one implementation, the one or more priority rules may be prioritizing the PSI report over the CSI report when the content of the PSI report includes a positioning fix of the UE.

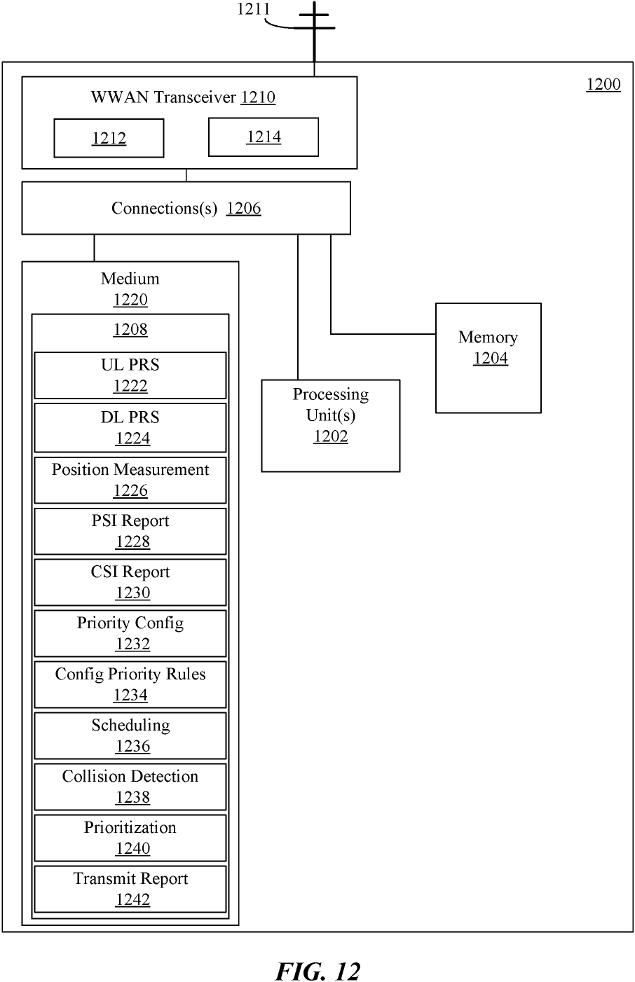

FIG. 12 shows a schematic block diagram illustrating certain exemplary features of a UE 1200, e.g., which may be UE 124 shown in FIG. 1, enabled to prioritize colliding PSI reports and/or colliding PSI and CSI reports based at least in part on positioning related content and to transmit the higher priority report on a lower layer channel to a network entity, according to the disclosure herein. UE 1200 may, for example, include one or more processors 1202, memory 1204, an external interface such as a wireless transceiver 1210 (e.g., wireless network interface), which may be operatively coupled with one or more connections 1206 (e.g., buses, lines, fibers, links, etc.) to non-transitory computer readable medium 1220 and memory 1204. The UE 1200 may further include additional items, which are not shown, such as a user interface that may include e.g., a display, a keypad or other input device, such as virtual keypad on the display, through which a user may interface with the UE, or a satellite positioning system receiver. In certain example implementations, all or part of UE 1200 may take the form of a chipset, and/or the like. Wireless transceiver 1210 may, for example, include a transmitter 1212 enabled to transmit one or more signals over one or more types of wireless communication networks and a receiver 1214 to receive one or more signals transmitted over the one or more types of wireless communication networks.

In some embodiments, UE 1200 may include antenna 1211, which may be internal or external. UE antenna 1211 may be used to transmit and/or receive signals processed by wireless transceiver 1210. In some embodiments, UE antenna 1211 may be coupled to wireless transceiver 1210. In some embodiments, measurements of signals received (transmitted) by UE 1200 may be performed at the point of connection of the UE antenna 1211 and wireless transceiver 1210. For example, the measurement point of reference for received (transmitted) RF signal measurements may be an input (output) terminal of the receiver 1214 (transmitter 1212) and an output (input) terminal of the UE antenna 1211. In a UE 1200 with multiple UE antennas 1211 or antenna arrays, the antenna connector may be viewed as a virtual point representing the aggregate output (input) of multiple UE antennas. UE 1200 may receive signals, e.g., DL PRS, and/or transmit UL PRS or SRS for positioning. Measurements of signals, including one or more of timing measurements, such RSTD, UE Rx-Tx, TOA, etc., energy measurements, such as RSRP, quality metrics, velocity and/or trajectory measurements, reference TRP, multipath information, line of sight (LOS) or non-line of sight (NLOS) factors, signal to interference noise ratio (SINR), and time stamps may be processed by the one or more processors 1202.

The one or more processors 1202 may be implemented using a combination of hardware, firmware, and software. For example, the one or more processors 1202 may be configured to perform the functions discussed herein by implementing one or more instructions or program code 1208 on a non-transitory computer readable medium, such as medium 1220 and/or memory 1204. In some embodiments, the one or more processors 1202 may represent one or more circuits configurable to perform at least a portion of a data signal computing procedure or process related to the operation of UE 1200.

The medium 1220 and/or memory 1204 may store instructions or program code 1208 that contain executable code or software instructions that when executed by the one or more processors 1202 cause the one or more processors 1202 to operate as a special purpose computer programmed to perform the techniques disclosed herein. As illustrated in UE 1200, the medium 1220 and/or memory 1204 may include one or more components or modules that may be implemented by the one or more processors 1202 to perform the methodologies described herein. While the components or modules are illustrated as software in medium 1220 that is executable by the one or more processors 1202, it should be understood that the components or modules may be stored in memory 1204 or may be dedicated hardware either in the one or more processors 1202 or off the processors.

A number of software modules and data tables may reside in the medium 1220 and/or memory 1204 and be utilized by the one or more processors 1202 in order to manage both communications and the functionality described herein. It should be appreciated that the organization of the contents of the medium 1220 and/or memory 1204 as shown in UE 1200 is merely exemplary, and as such the functionality of the modules and/or data structures may be combined, separated, and/or be structured in different ways depending upon the implementation of the UE 1200.

The medium 1220 and/or memory 1204 may include a UL PRS transmit module 1222 that when implemented by the one or more processors 1202 configures the one or more processors 1202 to transmit, via the wireless transceiver 1210, UL PRS or SRS for positioning.

The medium 1220 and/or memory 1204 may include a DL PRS module 1224 that when implemented by the one or more processors 1202 configures the one or more processors 1202 to receive, via the wireless transceiver 1210, DL PRS transmitted by one or more base stations.

The medium 1220 and/or memory 1204 may include a position measurement module 1226 that when implemented by the one or more processors 1202 configures the one or more processors 1202 to perform positioning measurements using received DL PRS and/or UL PRS. For example, the one or more processors 1202 may be configured to perform DL positioning measurements for one or more positioning methods based on received DL PRS, UL positioning measurements for one or more positioning methods based on transmitted UL PRS, or DL and UL positioning measurements for one or more positioning methods based on the received DL PRS and the transmitted UL PRS. Multiple positioning measurements may be performed, e.g., the same type of positioning measurements may be performed at different times and/or different types of positioning measurements may be performed at the same time or at different times. The positioning measurements may be for one or more positioning methods, such as TDOA, AoD, multi-RTT, hybrid positioning methods, etc. By way of example, the one or more processors 1202 may be configured for positioning measurements including one or more of, timing measurements such as RSTD, UE Rx-Tx, TOA, etc., energy measurements such as RSRP, quality metrics, velocity and/or trajectory measurements, reference TRP, multipath information, LOS/NLOS factors, SINR, and time stamps. In some implementations, the one or more processors 1202 may be further configured to estimate a position of the UE 1200 in a UE based positioning process using the position measurements and the locations of base stations, e.g., received in assistance data.

The medium 1220 and/or memory 1204 may include a PSI report module 1228 that when implemented by the one or more processors 1202 configures the one or more processors 1202 to generate a PSI report based information related to positioning measurements performed by the UE 1200. By way of example, the information related to positioning measurements used to determine the PSI report may include one or more of: at least one RSTD vector; at least one UE Rx-Tx vector; at least one RSRP vector; at least one quality metric; at least one velocity vector; a reference TRP; at least one TOA vector; at least one multipath vector; at least one LOS/ NLOS factor; at least one SINR vector; at least one time-stamp, e.g., each vector being a set of one or more measurements associated with at least one of a same time, a same TRP, same beam, same frequency band, same antenna, or a combination thereof.

The medium 1220 and/or memory 1204 may include a CSI report module 1230 that when implemented by the one or more processors 1202 configures the one or more processors 1202 to determine a CSI report based on measured radio channel quality parameters, such as CQI, PMI, RI, LI, L1-RSRP.

The medium 1220 and/or memory 1204 may include a priority configuration module 1232 that when implemented by the one or more processors 1202 configures the one or more processors 1202 to receive, via the wireless transceiver 1210, a priority based rules configuration based on positioning related content from a network entity, such as a serving base station, location server, or a sidelink UE.

The medium 1220 and/or memory 1204 may include a configure priority rules module 1234 that when implemented by the one or more processors 1202 configures the one or more processors 1202 to configure the priority rules to be used to prioritize PSI reports and/or PSI and CSI reports. The configuration for the priority rules, for example, may be received from a network entity and stored in medium and/or memory 1204. The configuration for the priority rules may be generated by the UE 1200 itself and stored in medium and/or memory 1204, and may be transmitted to a network entity with the PSI report. In some implementations, the configuration for the priority rules may be static and stored in medium and/or memory 1204. The configured priority rules, for example, may be based, at least in part, on the positioning related content, such as one or more of rules 1-12 for colliding PSI reports and rules 13-14 for colliding PSI and CSI reports. In some implementations, the priority rules may configured to include non-positioning content related rules, such as prioritizing according to time-domain behavior and physical channel before prioritizing based on positioning related content, or prioritizing based which serving cell the PSI report corresponds or based on the associated identifiers if the positioning related content is the same.

The medium 1220 and/or memory 1204 may include a scheduling module 1236 that when implemented by the one or more processors 1202 configures the one or more processors 1202 to determine a schedule for a lower layer channel container in which the PSI report is to be transmitted by the UE 1200, e.g., by receiving the grant from a serving base station, via the wireless transmitter.

The medium 1220 and/or memory 1204 may include a collision detection module 1238 that when implemented by the one or more processors 1202 configures the one or more processors 1202 to detect a collision between two or more PSI reports and/or between one or more PSI reports and a CSI report. For example, the one or more processors 1202 may be configured to determine when multiple PSI reports or at least one PSI report and a CSI report are scheduled to be transmitted simultaneously.

The medium 1220 and/or memory 1204 may include a prioritization module 1240 that when implemented by the one or more processors 1202 configures the one or more processors 1202 to prioritizes the PSI reports and/or the CSI report using the configured priority rules that are at least partially based on positioning related content. For example, the one or more processors 1202 may be configured to prioritize colliding PSI reports using priority rules that are based, at least in part, on the positioning related content, such as one or more of rules 1-12 discussed above, or other positioning related. In some implementations, the one or more processors 1202 may be further configured to prioritize colliding PSI reports based on non-positioning content related rules, such as prioritizing according to time-domain behavior and physical channel before prioritizing based on positioning related content, or prioritizing based which serving cell the PSI report corresponds or based on the associated identifiers if the positioning related content is the same. In another example, the one or more processors 1202 may be configured to prioritize one or more PSI reports colliding with a CSI report using priority rules that are based, at least in part, on the positioning related content, such as one or more of rules 13-14 discussed above, or other priority rule. In some implementations, the one or more processors 1202 may be further configured to prioritize colliding PSI and CSI reports based on non-positioning content related rules, such as prioritizing according to time-domain behavior and physical channel before prioritizing based on positioning related content.

The medium 1220 and/or memory 1204 may include a transmit report module 1242 that when implemented by the one or more processors 1202 configures the one or more processors 1202 to transmit the PSI or CSI report with the highest priority in an SL or UL lower layer channel container to a network entity, such as another UE, the serving base station, or location server, via the wireless transceiver 1210. For example, the UE 124 may transmit the PSI report using a PHY layer, e.g., using PUSCH, PUCCH, PSSCH, or on a MAC layer, using a MAC-CE block. The one or more processors 1202 is configured to omit the lower priority reports, i.e., lower priority reports are not transmitted. In some implementations, the one or more processors 1202 may be configured to indicate when a PSI report (or CSI report) is omitted from the transmission. Additionally, in instances where the UE 1200 determines the configuration for the priority rules, the one or more processors 1202 may be configured to include the priority rules configuration in the transmitted report.

The methodologies described herein may be implemented by various means depending upon the application. For example, these methodologies may be implemented in hardware, firmware, software, or any combination thereof. For a hardware implementation, the one or more processors 1202 may be implemented within one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine readable medium tangibly embodying instructions may be used in implementing the methodologies described herein. For example, software codes may be stored in a non-transitory computer readable medium 1220 or memory 1204 that is connected to and executed by the one or more processors 1202. Memory may be implemented within the one or more processors or external to the one or more processors. As used herein the term “memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or program code 1208 on a non-transitory computer readable medium, such as medium 1220 and/or memory 1204. Examples include computer readable media encoded with a data structure and computer readable media encoded with a computer program 1208. For example, the non-transitory computer readable medium including program code 1208 stored thereon may include program code 1208 to support prioritizing colliding PSI reports and/or colliding PSI and CSI reports based at least in part on positioning related content and to transmitting the higher priority report on a lower layer channel, according to the disclosure herein. Non-transitory computer readable medium 1220 includes physical computer storage media. A storage medium may be any available medium that can be accessed by a computer. By way of example, and not limitation, such non-transitory computer readable media can comprise RAM, ROM, EEPROM, CD-ROM or other optical disk storage, magnetic disk storage or other magnetic storage devices, or any other medium that can be used to store desired program code 1208 in the form of instructions or data structures and that can be accessed by a computer; disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer readable media.

In addition to storage on computer readable medium 1220, instructions and/or data may be provided as signals on transmission media included in a communication apparatus. For example, a communication apparatus may include a wireless transceiver 1210 having signals indicative of instructions and data. The instructions and data are configured to cause one or more processors to implement the functions outlined in the claims. That is, the communication apparatus includes transmission media with signals indicative of information to perform disclosed functions.

Memory 1204 may represent any data storage mechanism. Memory 1204 may include, for example, a primary memory and/or a secondary memory. Primary memory may include, for example, a random access memory, read only memory, etc. While illustrated in this example as being separate from one or more processors 1202, it should be understood that all or part of a primary memory may be provided within or otherwise co-located/coupled with the one or more processors 1202. Secondary memory may include, for example, the same or similar type of memory as primary memory and/or one or more data storage devices or systems, such as, for example, a disk drive, an optical disc drive, a tape drive, a solid state memory drive, etc.

In certain implementations, secondary memory may be operatively receptive of, or otherwise configurable to couple to a non-transitory computer readable medium 1220. As such, in certain example implementations, the methods and/or apparatuses presented herein may take the form in whole or part of a computer readable medium 1220 that may include computer implementable code 1208 stored thereon, which if executed by one or more processors 1202 may be operatively enabled to perform all or portions of the example operations as described herein. Computer readable medium 1220 may be a part of memory 1204.

In one implementation, a UE, such as UE 1200, may be configured for wireless communications and may include a means for determining a plurality of positioning state information (PSI) reports to be transmitted on a lower layer channel, wherein each of the plurality of PSI reports comprises information related to plurality of positioning measurements performed by the UE, which may be, e.g., the wireless transceiver 1210 and one or more processors 1202 with dedicated hardware or implementing executable code or software instructions in memory 1204 and/or medium 1220 such as the position measurement module 1226 and the PSI report module 1228. A means for detecting a collision of the plurality of PSI reports to be transmitted on the lower layer channel may be, e.g., the wireless transceiver 1210 and one or more processors 1202 with dedicated hardware or implementing executable code or software instructions in memory 1204 and/or medium 1220 such as the scheduling module 1236 and the collision detection module 1238. A means for performing prioritization of the plurality of PSI reports using one or more priority rules based at least in part on positioning related content of each of the plurality of PSI reports may be, e.g., the one or more processors 1202 with dedicated hardware or implementing executable code or software instructions in memory 1204 and/or medium 1220 such as the priority configuration module 1232 and the configure priority rules module 1234 and the prioritization module 1240. A means for transmitting one PSI report from the plurality of PSI reports based on prioritization to a network entity on the lower layer channel may be, e.g., the wireless transceiver 1210 and one or more processors 1202 with dedicated hardware or implementing executable code or software instructions in memory 1204 and/or medium 1220 such as the transmit report module 1242.

In one implementation, a UE, such as UE 1200, may be configured for wireless communications and may include a means for determining a positioning state information (PSI) report to be transmitted on a lower layer channel, wherein the PSI report comprises information related to plurality of positioning measurements performed by the UE, which may be, e.g., the wireless transceiver 1210 and one or more processors 1202 with dedicated hardware or implementing executable code or software instructions in memory 1204 and/or medium 1220 such as the position measurement module 1226 and the PSI report module 1228. A means for determining a channel state information (CSI) report to be transmitted on the lower layer channel may be, e.g., the wireless transceiver 1210 and one or more processors 1202 with dedicated hardware or implementing executable code or software instructions in memory 1204 and/or medium 1220 such as the CSI report module 1230. A means for detecting a collision of the PSI report and the CSI report to be transmitted on the lower layer channel may be, e.g., the wireless transceiver 1210 and one or more processors 1202 with dedicated hardware or implementing executable code or software instructions in memory 1204 and/or medium 1220 such as the scheduling module 1236 and the collision detection module 1238. A means for performing prioritization of the PSI report and CSI report using one or more priority rules may be, e.g., the one or more processors 1202 with dedicated hardware or implementing executable code or software instructions in memory 1204 and/or medium 1220 such as the priority configuration module 1232 and the configure priority rules module 1234 and the prioritization module 1240. A means for transmitting one of the PSI report and the CSI report based on prioritization to a network entity on the lower layer channel may be, e.g., the wireless transceiver 1210 and one or more processors 1202 with dedicated hardware or implementing executable code or software instructions in memory 1204 and/or medium 1220 such as the transmit report module 1242.

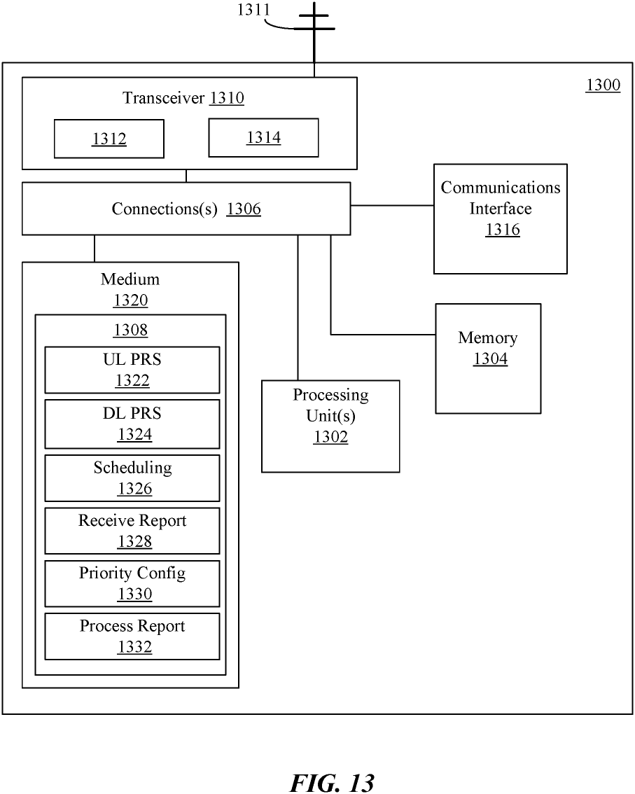

FIG. 13 shows a schematic block diagram illustrating certain exemplary features of a network entity 1300 in a wireless network enabled to support wireless communications with a UE, e.g., UE 104, to enable the UEto prioritize colliding PSI reports and/or colliding PSI and CSI reports based at least in part on positioning related content and to receive the higher priority report transmitted by the UE on a lower layer channel, according to the disclosure herein. The network entity 1300, for example, may be a serving base station 102 or location server 172 or LMF 270 in FIGS. 1 and 2B, or another UE in SL communication with UE. The network entity 1300 may, for example, include one or more processors 1302, memory 1304, and an external interface, which may include a wireless transceiver 1310 (e.g., wireless network interface), e.g., if the network entity 1300 is a serving base station or sidelink UE, and/or a communications interface 1316 (e.g., wireline or wireless network interface to other network entities and/or the core network), which may be operatively coupled with one or more connections 1306 (e.g., buses, lines, fibers, links, etc.) to non-transitory computer readable medium 1320 and memory 1304. In some implementations, the network entity 1300 may further include additional items, which are not shown, such as a user interface that may include e.g., a display, a keypad or other input device, such as virtual keypad on the display, through which a user may interface with the network entity, e.g., if the network entity is a sidelink UE. In certain example implementations, all or part of network entity 1300 may take the form of a chipset, and/or the like. Wireless transceiver 1310, if present, may, for example, include a transmitter 1312 enabled to transmit one or more signals over one or more types of wireless communication networks and a receiver 1314 to receive one or more signals transmitted over the one or more types of wireless communication networks. The communications interface 1316 may be a wired or wireless interface capable of connecting to other base stations, e.g., in the RAN or network entities, such as a location server 172 shown in FIG. 1.

In some embodiments, network entity 1300 may include antenna 1311, which may be internal or external. Antenna 1311 may be used to transmit and/or receive signals processed by wireless transceiver 1310. In some embodiments, antenna 1311 may be coupled to wireless transceiver 1310. In some embodiments, measurements of signals received (transmitted) by network entity 1300 may be performed at the point of connection of the antenna 1311 and wireless transceiver 1310. For example, the measurement point of reference for received (transmitted) RF signal measurements may be an input (output) terminal of the receiver 1314 (transmitter 1312) and an output (input) terminal of the antenna 1311. In a network entity 1300 with multiple antennas 1311 or antenna arrays, the antenna connector may be viewed as a virtual point representing the aggregate output (input) of multiple antennas. In some embodiments, network entity 1300 may measure received signals, (e.g., UL PRS or SRS for positioning) including signal strength and TOA measurements and the raw measurements may be processed by the one or more processors 1302.

The one or more processors 1302 may be implemented using a combination of hardware, firmware, and software. For example, the one or more processors 1302 may be configured to perform the functions discussed herein by implementing one or more instructions or program code 1308 on a non-transitory computer readable medium, such as medium 1320 and/or memory 1304. In some embodiments, the one or more processors 1302 may represent one or more circuits configurable to perform at least a portion of a data signal computing procedure or process related to the operation of network entity 1300.

The medium 1320 and/or memory 1304 may store instructions or program code 1308 that contain executable code or software instructions that when executed by the one or more processors 1302 cause the one or more processors 1302 to operate as a special purpose computer programmed to perform the techniques disclosed herein. As illustrated in network entity 1300, the medium 1320 and/or memory 1304 may include one or more components or modules that may be implemented by the one or more processors 1302 to perform the methodologies described herein. While the components or modules are illustrated as software in medium 1320 that is executable by the one or more processors 1302, it should be understood that the components or modules may be stored in memory 1304 or may be dedicated hardware either in the one or more processors 1302 or off the processors.

A number of software modules and data tables may reside in the medium 1320 and/or memory 1304 and be utilized by the one or more processors 1302 in order to manage both communications and the functionality described herein. It should be appreciated that the organization of the contents of the medium 1320 and/or memory 1304 as shown in network entity 1300 is merely exemplary, and as such the functionality of the modules and/or data structures may be combined, separated, and/or be structured in different ways depending upon the implementation of the network entity 1300.

The medium 1320 and/or memory 1304 may include a UL PRS transmit module 1322, e.g., if the network entity 1300 is a serving base station, that when implemented by the one or more processors 1302 configures the one or more processors 1302 to receive, via the wireless transceiver 1310, UL PRS or SRS for positioning, from the UE 104.

The medium 1320 and/or memory 1304 may include a DL PRS module 1324, e.g., if the network entity 1300 is a serving base station, that when implemented by the one or more processors 1302 configures the one or more processors 1302 to transmit, via the wireless transceiver 1310, DL PRS to the UE 104.

The medium 1320 and/or memory 1304 may include a scheduling module 1326, e.g., if the network entity 1300 is a serving base station, that when implemented by the one or more processors 1302 configures the one or more processors 1302 to schedule for a lower layer channel container in which a PSI report is to be transmitted by the UE 104, and transmit the schedule or grant to the UE 104, via the wireless transmitter.

The medium 1320 and/or memory 1304 may include a receive report module 1328 that when implemented by the one or more processors 1302 configures the one or more processors 1302 to receive a PSI report (or CSI report) in a lower layer channel container from the UE 104, e.g., via the wireless transceiver 1310 if the network entity 1300 is a sidelink UE or a serving base station, or a communications interface 1316 if the network entity 1300 is a location server. The lower layer channel container, for example, may be a SL channel if the network entity 1300 is another UE, or an UL channel if the network entity 1300 is a serving base station or location server. For example, the PSI report may be received on a PHY layer, e.g., using PUSCH, PUCCH, PSSCH, or on a MAC layer, using a MAC-CE. The PSI report may include information related to positioning measurements performed by the UE 104, wherein the PSI report was prioritized over one or more colliding PSI or CSI reports using priority rules based at least in part on positioning related content of the colliding reports. Colliding reports are not received in the transmission. In some implementations, the received report may include an indication when a PSI report (or CSI report) is omitted from the transmission. Additionally, in instances where the UE determines the configuration for the priority rules, the transmitted report may include the priority rules configuration.

The medium 1320 and/or memory 1304 may include a priority configuration module 1330 that when implemented by the one or more processors 1302 configures the one or more processors 1302 to configure the priority rules to be used by the UE to prioritize colliding PSI reports and/or colliding PSI and CSI reports. The configuration for the priority rules, for example, may be transmitted to the UE, e.g., via wireless transceiver 1310 or communications interface 1316. If the UE 104 generates the priority rules configuration, the one or more processors 1302 may be configured to receive the priority rules confirmation from the UE, e.g., in the PSI report. In some implementations, the configuration for the priority rules may be static and stored in medium and/or memory 1304.

The medium 1320 and/or memory 1304 may include a process report module 1332 that when implemented by the one or more processors 1302 configures the one or more processors 1302 to process the PSI (or CSI) report that is received, e.g., using the priority based rules.

The methodologies described herein may be implemented by various means depending upon the application. For example, these methodologies may be implemented in hardware, firmware, software, or any combination thereof. For a hardware implementation, the one or more processors 1302 may be implemented within one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine readable medium tangibly embodying instructions may be used in implementing the methodologies described herein. For example, software codes may be stored in a non-transitory computer readable medium 1320 or memory 1304 that is connected to and executed by the one or more processors 1302. Memory may be implemented within the one or more processors or external to the one or more processors. As used herein the term “memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or program code 1308 on a non-transitory computer readable medium, such as medium 1320 and/or memory 1304. Examples include computer readable media encoded with a data structure and computer readable media encoded with a computer program 1308. For example, the non-transitory computer readable medium including program code 1308 stored thereon may include program code 1308 to support the UE to prioritize colliding PSI reports and/or colliding PSI and CSI reports based at least in part on positioning related content and to receive the higher priority report on a lower layer channel, according to the disclosure herein. Non-transitory computer readable medium 1320 includes physical computer storage media. A storage medium may be any available medium that can be accessed by a computer. By way of example, and not limitation, such non-transitory computer readable media can comprise RAM, ROM, EEPROM, CD-ROM or other optical disk storage, magnetic disk storage or other magnetic storage devices, or any other medium that can be used to store desired program code 1308 in the form of instructions or data structures and that can be accessed by a computer; disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer readable media.

In addition to storage on computer readable medium 1320, instructions and/or data may be provided as signals on transmission media included in a communication apparatus. For example, a communication apparatus may include a wireless transceiver 1310 having signals indicative of instructions and data. The instructions and data are configured to cause one or more processors to implement the functions outlined in the claims. That is, the communication apparatus includes transmission media with signals indicative of information to perform disclosed functions.

Memory 1304 may represent any data storage mechanism. Memory 1304 may include, for example, a primary memory and/or a secondary memory. Primary memory may include, for example, a random access memory, read only memory, etc. While illustrated in this example as being separate from one or more processors 1302, it should be understood that all or part of a primary memory may be provided within or otherwise co-located/coupled with the one or more processors 1302. Secondary memory may include, for example, the same or similar type of memory as primary memory and/or one or more data storage devices or systems, such as, for example, a disk drive, an optical disc drive, a tape drive, a solid state memory drive, etc.

In certain implementations, secondary memory may be operatively receptive of, or otherwise configurable to couple to a non-transitory computer readable medium 1320. As such, in certain example implementations, the methods and/or apparatuses presented herein may take the form in whole or part of a computer readable medium 1320 that may include computer implementable code 1308 stored thereon, which if executed by one or more processors 1302 may be operatively enabled to perform all or portions of the example operations as described herein. Computer readable medium 1320 may be a part of memory 1304.

In one implementation, a network entity, such as network entity 1300, may be configured for wireless communications and may include a means for receiving from the UE a positioning state information (PSI) report in a lower layer channel, the PSI report comprising information related to positioning measurements performed by the UE, wherein the PSI report was prioritized over a second colliding PSI report using one or more priority rules based at least in part on positioning related content of the PSI report and the second colliding PSI report, which may be, e.g., the external interface including transceiver 1310 and communications interface 1316, one or more processors 1302 with dedicated hardware or implementing executable code or software instructions in memory 1304 and/or medium 1320 such as the receive report module 1328. A means for processing the PSI report may be, e.g., the one or more processors 1302 with dedicated hardware or implementing executable code or software instructions in memory 1304 and/or medium 1320 such as the process report module 1332.

In one implementation, the network entity may include a means for transmitting a prioritization configuration of the priority rules based on positioning related content to the UE, wherein the PSI report was prioritized over the second colliding PSI report based on the prioritization configuration of the priority rules, which may be, e.g., the external interface including transceiver 1310 and communications interface 1316, one or more processors 1302 with dedicated hardware or implementing executable code or software instructions in memory 1304 and/or medium 1320 such as the priority configuration module 1330.

In one implementation, a network entity, such as network entity 1300, may be configured for wireless communications and may include a means for receiving from the UE one of a channel state information (CSI) report or a positioning state information (PSI) report transmitted on a lower layer channel, the CSI report comprising content including one or more of a Channel Quality Information (CQI), Precoding Matrix Indicator (PMI), Rank Indicator (RI), Layer Indicator (LI), and Layer 1 Reference Signal Receive Power (L1-RSRP) and the PSI report comprising information related to positioning measurements performed by the UE, wherein the CSI report and the PSI report were colliding and the one of the CSI report or the PSI report was prioritized for transmission by the UE using one or more priority rules, which may be, e.g., the external interface including transceiver 1310 and communications interface 1316, one or more processors 1302 with dedicated hardware or implementing executable code or software instructions in memory 1304 and/or medium 1320 such as the receive report module 1328. A means for processing the one of the CSI report or the PSI report that is received may be, e.g., the one or more processors 1302 with dedicated hardware or implementing executable code or software instructions in memory 1304 and/or medium 1320 such as the process report module 1332.

In one implementation, the network entity may include a means for transmitting a prioritization configuration of the priority rules to the UE, wherein the one of the CSI report or the PSI report was prioritized based on the prioritization configuration of the priority rules, which may be, e.g., the external interface including transceiver 1310 and communications interface 1316, one or more processors 1302 with dedicated hardware or implementing executable code or software instructions in memory 1304 and/or medium 1320 such as the priority configuration module 1330.

Reference throughout this specification to “one example”, “an example”, “certain examples”, or “exemplary implementation” means that a particular feature, structure, or characteristic described in connection with the feature and/or example may be included in at least one feature and/or example of claimed subject matter. Thus, the appearances of the phrase “in one example”, “an example”, “in certain examples” or “in certain implementations” or other like phrases in various places throughout this specification are not necessarily all referring to the same feature, example, and/or limitation. Furthermore, the particular features, structures, or characteristics may be combined in one or more examples and/or features.

Some portions of the detailed description included herein are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular operations pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer, special purpose computing apparatus or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter.

The terms, “and”, “or”, and “and/or” as used herein may include a variety of meanings that also are expected to depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein may be used to describe any feature, structure, or characteristic in the singular or may be used to describe a plurality or some other combination of features, structures or characteristics. Though, it should be noted that this is merely an illustrative example and claimed subject matter is not limited to this example.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein.

Implementation examples are described in the following numbered clauses:
1. A method for a user equipment (UE) wireless communications performed by the UE, comprising:
determining a plurality of positioning state information (PSI) reports to be transmitted on a lower layer channel, wherein each of the plurality of PSI reports comprises information related to plurality of positioning measurements performed by the UE;
detecting a collision of the plurality of PSI reports to be transmitted on the lower layer channel;
performing prioritization of the plurality of PSI reports using one or more priority rules based at least in part on positioning related content of each of the plurality of PSI reports; and
transmitting one PSI report from the plurality of PSI reports based on prioritization to a network entity on the lower layer channel.
2. The method of clause 1, wherein the lower layer channel comprises either a Physical layer channel or a Medium Access Control (MAC) layer channel.
3. The method of clause 2, wherein the physical layer channel comprises either a physical uplink shared channel (PUSCH), a physical uplink control channel (PUCCH), or a physical sidelink shared channel (PSSCH), and the MAC layer channel comprises a MAC - control element (MAC-CE).
4. The method of any of clauses 1-3, wherein transmitting the one PSI report from the plurality of PSI reports based on prioritization comprises not transmitting remaining PSI reports in the plurality of PSI reports.
5. The method of any of clauses 1-4, wherein the one or more priority rules based at least in part on the positioning related content comprise prioritizing a PSI report carrying a first type of positioning measurement over a PSI report carrying a second type of positioning measurements.
6. The method of any of clauses 1-5, wherein the one or more priority rules based at least in part on the positioning related content comprise prioritizing a PSI report carrying a timing measurement over a PSI report carrying only energy measurements.
7. The method of any of clauses 1-6, wherein the one or more priority rules based at least in part on the positioning related content comprise prioritizing a PSI report carrying first-arrival measurements over a PSI report carrying multipath measurements.
8. The method of any of clauses 1-7, wherein the one or more priority rules based at least in part on the positioning related content comprise prioritizing a PSI report carrying Reference Signal Time Difference (RSTD) measurements from an Time Difference of Arrival (TDOA) positioning session over a PSI report carrying Reference Signal Receive Power (RSRP) from the TDOA positioning session.
9. The method of any of clauses 1-8, wherein the one or more priority rules based at least in part on the positioning related content comprise prioritizing a PSI report carrying receive-transmit time difference (Rx-Tx) measurements from a multi-Round Trip Time (RTT) positioning session over a PSI report carrying Reference Signal Receive Power (RSRP) from the multi-RTT positioning session.
10. The method of any of clauses 1-9, wherein the one or more priority rules based at least in part on the positioning related content comprise prioritizing a PSI report carrying Reference Signal Receive Power (RSRP) measurements from an Angle of Departure (AOD) positioning session over a PSI report carrying timing measurements from the AOD positioning session.
11. The method of any of clauses 1-10, wherein the one or more priority rules based at least in part on the positioning related content comprise prioritizing a PSI report carrying multiple types of positioning measurement over a PSI report carrying a single type of positioning measurement.
12. The method of any of clauses 1-11, wherein the one or more priority rules based at least in part on the positioning related content comprise prioritizing a PSI report carrying positioning measurements from a reference Transmission Reception Point (TRP) over a PSI report carrying positioning measurement from only one or more neighboring TRPs.
13. The method of any of clauses 1-12, wherein the one or more priority rules based at least in part on the positioning related content comprise prioritizing a PSI report carrying timing or energy positioning measurement over a PSI report carrying velocity information.
14. The method of any of clauses 1-13, wherein the one or more priority rules based at least in part on the positioning related content comprise prioritizing a PSI report carrying positioning measurements derived from a downlink (DL) or uplink (UL) positioning reference signals (PRS) over a PSI report carrying positioning measurements derived from non-PRS signals.
15. The method of any of clauses 1-14, wherein the one or more priority rules based at least in part on the positioning related content comprise prioritizing a PSI report carrying one or more positioning fixes for the UE over a PSI report carrying positioning measurements.
16. The method of any of clauses 1-15, wherein the one or more priority rules based at least in part on the positioning related content comprise prioritizing a PSI report carrying a latest timestamp over a PSI report carrying an earlier timestamp.
17. The method of any of clauses 1-16, wherein the one or more priority rules based at least in part on the positioning related content comprise prioritizing a PSI report carrying positioning measurements derived from an intra-frequency measurement over a PSI report carrying positioning measurements derived from inter-frequency measurements, wherein intra-frequency measurements comprise measurements performed on the same positioning frequency layer and inter-frequency measurements comprise measurements performed across at least two different positioning frequency layers.
18. A user equipment (UE) configured for wireless communications, comprising:
   a wireless transceiver configured to wirelessly communicate with a network entity in a wireless communication system;
   at least one memory;
   at least one processor coupled to the wireless transceiver and the at least one memory, wherein the at least one processor is configured to:
   determine a plurality of positioning state information (PSI) reports to be transmitted on a lower layer channel, wherein each of the plurality of PSI reports comprises information related to plurality of positioning measurements performed by the UE;
   detect a collision of the plurality of PSI reports to be transmitted on the lower layer channel;
   perform prioritization of the plurality of PSI reports using one or more priority rules based at least in part on positioning related content of each of the plurality of PSI reports; and
   transmit one PSI report from the plurality of PSI reports based on prioritization to the network entity on the lower layer channel.
19. The UE of clause 18, wherein the lower layer channel comprises either a Physical layer channel or a Medium Access Control (MAC) layer channel.
20. The UE of clause 19, wherein the physical layer channel comprises either a physical uplink shared channel (PUSCH), a physical uplink control channel (PUCCH), or a physical sidelink shared channel (PSSCH), and the MAC layer channel comprises a MAC - control element (MAC-CE).
21. The UE of any of clauses 18-20, wherein the at least one processor is configured to transmit the one PSI report from the plurality of PSI reports based on prioritization and to not transmit remaining PSI reports in the plurality of PSI reports.
22. The UE of any of clauses 18-21, wherein the one or more priority rules based at least in part on the positioning related content comprise prioritizing a PSI report carrying a first type of positioning measurement over a PSI report carrying a second type of positioning measurements.
23. The UE of any of clauses 18-22, wherein the one or more priority rules based at least in part on the positioning related content comprise prioritizing a PSI report carrying a timing measurement over a PSI report carrying only energy measurements.
24. The UE of any of clauses 18-23, wherein the one or more priority rules based at least in part on the positioning related content comprise prioritizing a PSI report carrying first-arrival measurements over a PSI report carrying multipath measurements.
25. The UE of any of clauses 18-24, wherein the one or more priority rules based at least in part on the positioning related content comprise prioritizing a PSI report carrying Reference Signal Time Difference (RSTD) measurements from an Time Difference of Arrival (TDOA) positioning session over a PSI report carrying Reference Signal Receive Power (RSRP) from the TDOA positioning session.
26. The UE of any of clauses 18-25, wherein the one or more priority rules based at least in part on the positioning related content comprise prioritizing a PSI report carrying receive-transmit time difference (Rx-Tx) measurements from a multi-Round Trip Time (RTT) positioning session over a PSI report carrying Reference Signal Receive Power (RSRP) from the multi-RTT positioning session.
27. The UE of any of clauses 18-26, wherein the one or more priority rules based at least in part on the positioning related content comprise prioritizing a PSI report carrying Reference Signal Receive Power (RSRP) measurements from an Angle of Departure (AOD) positioning session over a PSI report carrying timing measurements from the AOD positioning session.
28. The UE of any of clauses 18-27, wherein the one or more priority rules based at least in part on the positioning related content comprise prioritizing a PSI report carrying multiple types of positioning measurement over a PSI report carrying a single type of positioning measurement.
29. The UE of any of clauses 18-28, wherein the one or more priority rules based at least in part on the positioning related content comprise prioritizing a PSI report carrying positioning measurements from a reference Transmission Reception Point (TRP) over a PSI report carrying positioning measurement from only one or more neighboring TRPs.
30. The UE of any of clauses 18-29, wherein the one or more priority rules based at least in part on the positioning related content comprise prioritizing a PSI report carrying timing or energy positioning measurement over a PSI report carrying velocity information.
31. The UE of any of clauses 18-30, wherein the one or more priority rules based at least in part on the positioning related content comprise prioritizing a PSI report carrying positioning measurements derived from a downlink (DL) or uplink (UL) positioning reference signals (PRS) over a PSI report carrying positioning measurements derived from non-PRS signals.
32. The UE of any of clauses 18-31, wherein the one or more priority rules based at least in part on the positioning related content comprise prioritizing a PSI report carrying one or more positioning fixes for the UE over a PSI report carrying positioning measurements.
33. The UE of any of clauses 18-32, wherein the one or more priority rules based at least in part on the positioning related content comprise prioritizing a PSI report carrying a latest timestamp over a PSI report carrying an earlier timestamp.
34. The UE of any of clauses 18-33, wherein the one or more priority rules based at least in part on the positioning related content comprise prioritizing a PSI report carrying positioning measurements derived from an intra-frequency measurement over a PSI report carrying positioning measurements derived from inter-frequency measurements, wherein intra-frequency measurements comprise measurements performed on the same positioning frequency layer and inter-frequency measurements comprise measurements performed across at least two different positioning frequency layers.
35. A user equipment (UE) configured for wireless communications, comprising:
   means for determining a plurality of positioning state information (PSI) reports to be transmitted on a lower layer channel, wherein each of the plurality of PSI reports comprises information related to plurality of positioning measurements performed by the UE;
   means for detecting a collision of the plurality of PSI reports to be transmitted on the lower layer channel;
   means for performing prioritization of the plurality of PSI reports using one or more priority rules based at least in part on positioning related content of each of the plurality of PSI reports; and
   means for transmitting one PSI report from the plurality of PSI reports based on prioritization to a network entity on the lower layer channel.
36. A non-transitory storage medium including program code stored thereon, the program code is operable to configure at least one processor in a user equipment (UE) for wireless communications, comprising:
   program code to determine a plurality of positioning state information (PSI) reports to be transmitted on a lower layer channel, wherein each of the plurality of PSI reports comprises information related to plurality of positioning measurements performed by the UE;
   program code to detect a collision of the plurality of PSI reports to be transmitted on the lower layer channel;
   program code to perform prioritization of the plurality of PSI reports using one or more priority rules based at least in part on positioning related content of each of the plurality of PSI reports; and
   program code to transmit one PSI report from the plurality of PSI reports based on prioritization to a network entity on the lower layer channel.
37. A method for a user equipment (UE) wireless communications performed by the UE, comprising:
   determining a positioning state information (PSI) report to be transmitted on a lower layer channel, wherein the PSI report comprises content related to positioning measurements performed by the UE;
   determining a channel state information (CSI) report to be transmitted on the lower layer channel;
   detecting a collision of the PSI report and the CSI report to be transmitted on the lower layer channel;
   performing prioritization of the PSI report and CSI report using one or more priority rules; and
   transmitting one of the PSI report and the CSI report based on prioritization to a network entity on the lower layer channel.
38. The method of clause 37, wherein the lower layer channel comprises either a Physical layer channel or a Medium Access Control (MAC) layer channel.
39. The method of clause 38, wherein the physical layer channel comprises either a physical uplink shared channel (PUSCH), a physical uplink control channel (PUCCH), or a physical sidelink shared channel (PSSCH), and the MAC layer channel comprises a MAC - control element (MAC-CE).
40. The method of any of clauses 37-39, wherein transmitting the one of the PSI report and the CSI report based on prioritization comprises not transmitting a remaining one of the PSI report and the CSI report.
41. The method of any of clauses 37-40, wherein performing prioritization of the PSI report and CSI report using one or more priority rules comprises prioritizing the CSI report over the PSI report regardless of the content of the PSI report.
42. The method of any of clauses 37-41, wherein performing prioritization of the PSI report and CSI report using one or more priority rules comprises prioritizing the PSI report over the CSI report when the content of the PSI report includes a positioning fix of the UE.
43. A user equipment (UE) configured for wireless communications, comprising:
   a wireless transceiver configured to wirelessly communicate with a network entity in a wireless communication system;
   at least one memory;
   at least one processor coupled to the wireless transceiver and the at least one memory, wherein the at least one processor is configured to:
   determine a positioning state information (PSI) report to be transmitted on a lower layer channel, wherein the PSI report comprises content related to positioning measurements performed by the UE;
   determine a channel state information (CSI) report to be transmitted on the lower layer channel;
   detect a collision of the PSI report and the CSI report to be transmitted on the lower layer channel;
   perform prioritization of the PSI report and CSI report using one or more priority rules; and
   transmit one of the PSI report and the CSI report based on prioritization to the network entity on the lower layer channel.
44. The UE of clause 43, wherein the lower layer channel comprises either a Physical layer channel or a Medium Access Control (MAC) layer channel.
45. The UE of clause 44, wherein the physical layer channel comprises either a physical uplink shared channel (PUSCH), a physical uplink control channel (PUCCH), or a physical sidelink shared channel (PSSCH), and the MAC layer channel comprises a MAC - control element (MAC-CE).
46. The UE of any of clauses 43-45, wherein the at least one processor is configured to transmit the one of the PSI report and the CSI report based on prioritization and not transmit a remaining one of the PSI report and the CSI report.
47. The UE of any of clauses 43-46, wherein performing prioritization of the PSI report and CSI report using one or more priority rules comprises prioritizing the CSI report over the PSI report regardless of the content of the PSI report.
48. The UE of any of clauses 43-47, wherein performing prioritization of the PSI report and CSI report using one or more priority rules comprises prioritizing the PSI report over the CSI report when the content of the PSI report includes a positioning fix of the UE.
49. A user equipment (UE) configured for wireless communications, comprising:
   means for determining a positioning state information (PSI) report to be transmitted on a lower layer channel, wherein the PSI report comprises content related to positioning measurements performed by the UE;
   means for determining a channel state information (CSI) report to be transmitted on the lower layer channel;
   means for detecting a collision of the PSI report and the CSI report to be transmitted on the lower layer channel;
   means for performing prioritization of the PSI report and CSI report using one or more priority rules; and
   means for transmitting one of the PSI report and the CSI report based on prioritization to a network entity on the lower layer channel.
50. A non-transitory storage medium including program code stored thereon, the program code is operable to configure at least one processor in a user equipment (UE) for wireless communications, comprising:
   program code to determine a positioning state information (PSI) report to be transmitted on a lower layer channel, wherein the PSI report comprises content related to positioning measurements performed by the UE;
   program code to determine a channel state information (CSI) report to be transmitted on the lower layer channel;
   program code to detect a collision of the PSI report and the CSI report to be transmitted on the lower layer channel;
   program code to perform prioritization of the PSI report and CSI report using one or more priority rules; and
   program code to transmit one of the PSI report and the CSI report based on prioritization to a network entity on the lower layer channel.
51. A method for a user equipment (UE) wireless communications performed by a network entity in a wireless network, comprising:
   receiving from the UE a positioning state information (PSI) report in a lower layer channel, the PSI report comprising information related to positioning measurements performed by the UE, wherein the PSI report was prioritized over a second colliding PSI report using one or more priority rules based at least in part on positioning related content of the PSI report and the second colliding PSI report; and
   processing the PSI report.
52. The method of clause 51, further comprising:
   transmitting a prioritization configuration of the priority rules based on positioning related content to the UE, wherein the PSI report was prioritized over the second colliding PSI report based on the prioritization configuration of the priority rules.
53. The method of either of clauses 51 or 52, wherein the network entity comprises one of a location server, a serving base station, or a sidelink UE.
54. The method of any of clauses 51-53, wherein the lower layer channel comprises either a Physical layer channel or a Medium Access Control (MAC) layer channel.
55. The method of clause 54, wherein the physical layer channel comprises either a physical uplink shared channel (PUSCH), a physical uplink control channel (PUCCH), or a physical sidelink shared channel (PSSCH), and the MAC layer channel comprises a MAC - control element (MAC-CE).
56. The method of any of clauses 51-55, wherein the second colliding PSI report is not received from the UE.
57. The method of any of clauses 51-56, wherein the one or more priority rules based at least in part on the positioning related content comprise prioritizing a PSI report carrying a first type of positioning measurement over a PSI report carrying a second type of positioning measurements.
58. The method of any of clauses 51-57, wherein the one or more priority rules based at least in part on the positioning related content comprise prioritizing a PSI report carrying a timing measurement over a PSI report carrying only energy measurements.
59. The method of any of clauses 51-58, wherein the one or more priority rules based at least in part on the positioning related content comprise prioritizing a PSI report carrying first-arrival measurements over a PSI report carrying multipath measurements.
60. The method of any of clauses 51-59, wherein the one or more priority rules based at least in part on the positioning related content comprise prioritizing a PSI report carrying Reference Signal Time Difference (RSTD) measurements from an Time Difference of Arrival (TDOA) positioning session over a PSI report carrying Reference Signal Receive Power (RSRP) from the TDOA positioning session.
61. The method of any of clauses 51-60, wherein the one or more priority rules based at least in part on the positioning related content comprise prioritizing a PSI report carrying receive-transmit time difference (Rx-Tx) measurements from a multi-Round Trip Time (RTT) positioning session over a PSI report carrying Reference Signal Receive Power (RSRP) from the multi-RTT positioning session.
62. The method of any of clauses 51-61, wherein the one or more priority rules based at least in part on the positioning related content comprise prioritizing a PSI report carrying Reference Signal Receive Power (RSRP) measurements from an Angle of Departure (AOD) positioning session over a PSI report carrying timing measurements from the AOD positioning session.
63. The method of any of clauses 51-62, wherein the one or more priority rules based at least in part on the positioning related content comprise prioritizing a PSI report carrying multiple types of positioning measurement over a PSI report carrying a single type of positioning measurement.
64. The method of any of clauses 51-63, wherein the one or more priority rules based at least in part on the positioning related content comprise prioritizing a PSI report carrying positioning measurements from a reference Transmission Reception Point (TRP) over a PSI report carrying positioning measurement from only one or more neighboring TRPs.
65. The method of any of clauses 51-64, wherein the one or more priority rules based at least in part on the positioning related content comprise prioritizing a PSI report carrying timing or energy positioning measurement over a PSI report carrying velocity information.
66. The method of any of clauses 51-65, wherein the one or more priority rules based at least in part on the positioning related content comprise prioritizing a PSI report carrying positioning measurements derived from a downlink (DL) or uplink (UL) positioning reference signals (PRS) over a PSI report carrying positioning measurements derived from non-PRS signals.
67. The method of any of clauses 51-66, wherein the one or more priority rules based at least in part on the positioning related content comprise prioritizing a PSI report carrying one or more positioning fixes for the UE over a PSI report carrying positioning measurements.
68. The method of any of clauses 51-67, wherein the one or more priority rules based at least in part on the positioning related content comprise prioritizing a PSI report carrying a latest timestamp over a PSI report carrying an earlier timestamp.
69. The method of any of clauses 51-68, wherein the one or more priority rules based at least in part on the positioning related content comprise prioritizing a PSI report carrying positioning measurements derived from on intra-frequency measurement over a PSI report carrying positioning measurements derived from inter-frequency measurements, wherein intra-frequency measurements comprise measurements performed on the same positioning frequency layer and inter-frequency measurements comprise measurements performed across at least two different positioning frequency layers.
70. A network entity in a wireless network configured to support wireless communications of a user equipment (UE), comprising:
   an external interface configured to wirelessly communicate with the UE;
   at least one memory;
   at least one processor coupled to the external interface and the at least one memory, wherein the at least one processor is configured to:
   receive from the UE a positioning state information (PSI) report in a lower layer channel, the PSI report comprising information related to positioning measurements performed by the UE, wherein the PSI report was prioritized over a second colliding PSI report using one or more priority rules based at least in part on positioning related content of the PSI report and the second colliding PSI report; and
   process the PSI report.
71. The network entity of clause 70, wherein the at least one processor is further configured to:
   transmit a prioritization configuration of the one or more priority rules based on positioning related content to the UE, wherein the PSI report was prioritized over the second colliding PSI report based on the prioritization configuration of the one or more priority rules.
72. The network entity of either of clauses 70 or 71, wherein the network entity comprises one of a location server, a serving base station, or a sidelink UE.
73. The network entity of any of clauses 70-72, wherein the lower layer channel comprises either a Physical layer channel or a Medium Access Control (MAC) layer channel.
74. The network entity of clause 73, wherein the physical layer channel comprises either a physical uplink shared channel (PUSCH), a physical uplink control channel (PUCCH), or a physical sidelink shared channel (PSSCH), and the MAC layer channel comprises a MAC - control element (MAC-CE).
75. The network entity of any of clauses 70-74, wherein the second colliding PSI report is not received from the UE.
76. The network entity of any of clauses 70-75, wherein the one or more priority rules based at least in part on the positioning related content comprise prioritizing a PSI report carrying a first type of positioning measurement over a PSI report carrying a second type of positioning measurements.
77. The network entity of any of clauses 70-76, wherein the one or more priority rules based at least in part on the positioning related content comprise prioritizing a PSI report carrying a timing measurement over a PSI report carrying only energy measurements.
78. The network entity of any of clauses 70-77, wherein the one or more priority rules based at least in part on the positioning related content comprise prioritizing a PSI report carrying first-arrival measurements over a PSI report carrying multipath measurements.
79. The network entity of any of clauses 70-78, wherein the one or more priority rules based at least in part on the positioning related content comprise prioritizing a PSI report carrying Reference Signal Time Difference (RSTD) measurements from an Time Difference of Arrival (TDOA) positioning session over a PSI report carrying Reference Signal Receive Power (RSRP) from the TDOA positioning session.
80. The network entity of any of clauses 70-79, wherein the one or more priority rules based at least in part on the positioning related content comprise prioritizing a PSI report carrying receive-transmit time difference (Rx-Tx) measurements from a multi-Round Trip Time (RTT) positioning session over a PSI report carrying Reference Signal Receive Power (RSRP) from the multi-RTT positioning session.
81. The network entity of any of clauses 70-80, wherein the one or more priority rules based at least in part on the positioning related content comprise prioritizing a PSI report carrying Reference Signal Receive Power (RSRP) measurements from an Angle of Departure (AOD) positioning session over a PSI report carrying timing measurements from the AOD positioning session.
82. The network entity of any of clauses 70-81, wherein the one or more priority rules based at least in part on the positioning related content comprise prioritizing a PSI report carrying multiple types of positioning measurement over a PSI report carrying a single type of positioning measurement.
83. The network entity of any of clauses 70-82, wherein the one or more priority rules based at least in part on the positioning related content comprise prioritizing a PSI report carrying positioning measurements from a reference Transmission Reception Point (TRP) over a PSI report carrying positioning measurement from only one or more neighboring TRPs.
84. The network entity of any of clauses 70-83, wherein the one or more priority rules based at least in part on the positioning related content comprise prioritizing a PSI report carrying timing or energy positioning measurement over a PSI report carrying velocity information.
85. The network entity of any of clauses 70-84, wherein the one or more priority rules based at least in part on the positioning related content comprise prioritizing a PSI report carrying positioning measurements derived from a downlink (DL) or uplink (UL) positioning reference signals (PRS) over a PSI report carrying positioning measurements derived from non-PRS signals.
86. The network entity of any of clauses 70-85, wherein the one or more priority rules based at least in part on the positioning related content comprise prioritizing a PSI report carrying one or more positioning fixes for the UE over a PSI report carrying positioning measurements.
87. The network entity of any of clauses 70-86, wherein the one or more priority rules based at least in part on the positioning related content comprise prioritizing a PSI report carrying a latest timestamp over a PSI report carrying an earlier timestamp.
88. The network entity of any of clauses 70-87, wherein the one or more priority rules based at least in part on the positioning related content comprise prioritizing a PSI report carrying positioning measurements derived from on intra-frequency measurement over a PSI report carrying positioning measurements derived from inter-frequency measurements, wherein intra-frequency measurements comprise measurements performed on the same positioning frequency layer and inter-frequency measurements comprise measurements performed across at least two different positioning frequency layers.
89. A network entity in a wireless network configured to support wireless communications of a user equipment (UE), comprising:
means for receiving from the UE a positioning state information (PSI) report in a lower layer channel, the PSI report comprising information related to positioning measurements performed by the UE, wherein the PSI report was prioritized over a second colliding PSI report using one or more priority rules based at least in part on positioning related content of the PSI report and the second colliding PSI report; and
   means for processing the PSI report.
90. A non-transitory storage medium including program code stored thereon, the program code is operable to configure at least one processor in a network entity in a wireless network to support wireless communications of a user equipment (UE), comprising:
   program code to receive from the UE a positioning state information (PSI) report in a lower layer channel, the PSI report comprising information related to positioning measurements performed by the UE, wherein the PSI report was prioritized over a second colliding PSI report using one or more priority rules based at least in part on positioning related content of the PSI report and the second colliding PSI report; and
   program code to process the PSI report.
91. A method for a user equipment (UE) wireless communications performed by a network entity in a wireless network, comprising:
   receiving from the UE one of a channel state information (CSI) report or a positioning state information (PSI) report transmitted on a lower layer channel, the CSI report comprising content including one or more of a Channel Quality Information (CQI), Precoding Matrix Indicator (PMI), Rank Indicator (RI), Layer Indicator (LI), and Layer 1 Reference Signal Receive Power (L1-RSRP) and the PSI report comprising information related to positioning measurements performed by the UE, wherein the CSI report and the PSI report were colliding and the one of the CSI report or the PSI report was prioritized for transmission by the UE using one or more priority rules; and
   processing the one of the CSI report or the PSI report that is received.
92. The method of clause 91, further comprising:
   transmitting a prioritization configuration of the priority rules to the UE, wherein the one of the CSI report or the PSI report was prioritized based on the prioritization configuration of the priority rules.
93. The method of either of clauses 91 or 92, wherein the network entity comprises one of a location server, a serving base station, or a sidelink UE.
94. The method of any of clauses 91-93, wherein the lower layer channel comprises either a Physical layer channel or a Medium Access Control (MAC) layer channel.
95. The method of clause 94, wherein the physical layer channel comprises either a physical uplink shared channel (PUSCH), a physical uplink control channel (PUCCH), or a physical sidelink shared channel (PSSCH), and the MAC layer channel comprises a MAC - control element (MAC-CE).
96. The method of any of clauses 91-95, wherein a remaining one of the PSI report and the CSI report is not received from the UE.
97. The method of any of clauses 91-96, wherein the one or more priority rules comprise prioritizing the CSI report over the PSI report regardless of the content of the PSI report.
98. The method of any of clauses 91-97, wherein the one or more priority rules comprise prioritizing the PSI report over the CSI report when the content of the PSI report includes a positioning fix of the UE.
99. A network entity in a wireless network configured to support wireless communications of a user equipment (UE), comprising:
   an external interface configured to wirelessly communicate with the UE;
   at least one memory;
   at least one processor coupled to the external interface and the at least one memory, wherein the at least one processor is configured to:
   receive from the UE one of a channel state information (CSI) report or a positioning state information (PSI) report transmitted on a lower layer channel, the CSI report comprising content including one or more of a Channel Quality Information (CQI), Precoding Matrix Indicator (PMI), Rank Indicator (RI), Layer Indicator (LI), and Layer 1 Reference Signal Receive Power (L1-RSRP) and the PSI report comprising information related to positioning measurements performed by the UE, wherein the CSI report and the PSI report were colliding and the one of the CSI report or the PSI report was prioritized for transmission by the UE using one or more priority rules; and
   process the one of the CSI report or the PSI report that is received.
   100. The network entity of clause 99, wherein the at least one processor is further configured to:
   transmit a prioritization configuration of the priority rules to the UE, wherein the one of the CSI report or the PSI report was prioritized based on the prioritization configuration of the priority rules.
101. The network entity of either of clauses 99 or 100, wherein the network entity comprises one of a location server, a serving base station, or a sidelink UE.
102. The network entity of any of clauses 99-101, wherein the lower layer channel comprises either a Physical layer channel or a Medium Access Control (MAC) layer channel.
103. The network entity of clause 102, wherein the physical layer channel comprises either a physical uplink shared channel (PUSCH), a physical uplink control channel (PUCCH), or a physical sidelink shared channel (PSSCH), and the MAC layer channel comprises a MAC - control element (MAC-CE).
104. The network entity of any of clauses 99-103, wherein a remaining one of the PSI report and the CSI report is not received from the UE.
105. The network entity of any of clauses 99-104, wherein the one or more priority rules comprise prioritizing the CSI report over the PSI report regardless of the content of the PSI report.
106. The network entity of any of clauses 99-105, wherein the one or more priority rules comprise prioritizing the PSI report over the CSI report when the content of the PSI report includes a positioning fix of the UE.
107. A network entity in a wireless network configured to support wireless communications of a user equipment (UE), comprising:
   means for receiving from the UE one of a channel state information (CSI) report or a positioning state information (PSI) report transmitted on a lower layer channel, the CSI report comprising content including one or more of a Channel Quality Information (CQI), Precoding Matrix Indicator (PMI), Rank Indicator (RI), Layer Indicator (LI), and Layer 1 Reference Signal Receive Power (L1-RSRP) and the PSI report comprising information related to positioning measurements performed by the UE, wherein the CSI report and the PSI report were colliding and the one of the CSI report or the PSI report was prioritized for transmission by the UE using one or more priority rules; and
   means for processing the one of the CSI report or the PSI report that is received.
108. A non-transitory storage medium including program code stored thereon, the program code is operable to configure at least one processor in a network entity in a wireless network to support wireless communications of a user equipment (UE), comprising:
   program code to receive from the UE one of a channel state information (CSI) report or a positioning state information (PSI) report transmitted on a lower layer channel, the CSI report comprising content including one or more of a Channel Quality Information (CQI), Precoding Matrix Indicator (PMI), Rank Indicator (RI), Layer Indicator (LI), and Layer 1 Reference Signal Receive Power (L1-RSRP) and the PSI report comprising information related to positioning measurements performed by the UE, wherein the CSI report and the PSI report were colliding and the one of the CSI report or the PSI report was prioritized for transmission by the UE using one or more priority rules; and
   program code to process the one of the CSI report or the PSI report that is received.

Therefore, it is intended that claimed subject matter not be limited to the particular examples disclosed, but that such claimed subject matter may also include all aspects falling within the scope of appended claims, and equivalents thereof.

1. A method for a user equipment (UE) wireless communications performed by the UE, comprising:
determining a plurality of positioning state information (PSI) reports to be transmitted on a lower layer channel, wherein each of the plurality of PSI reports comprises information related to plurality of positioning measurements performed by the UE;
detecting a collision of the plurality of PSI reports to be transmitted on the lower layer channel;
performing prioritization of the plurality of PSI reports using one or more priority rules based at least in part on positioning related content of each of the plurality of PSI reports; and
transmitting one PSI report from the plurality of PSI reports based on prioritization to a network entity on the lower layer channel.

2-17. (canceled)

18. A user equipment (UE) configured for wireless communications, comprising:
a wireless transceiver configured to wirelessly communicate with a network entity in a wireless communication system;
at least one memory;
at least one processor coupled to the wireless transceiver and the at least one memory, wherein the at least one processor is configured to:
determine a plurality of positioning state information (PSI) reports to be transmitted on a lower layer channel, wherein each of the plurality of PSI reports comprises information related to plurality of positioning measurements performed by the UE;
detect a collision of the plurality of PSI reports to be transmitted on the lower layer channel;
perform prioritization of the plurality of PSI reports using one or more priority rules based at least in part on positioning related content of each of the plurality of PSI reports; and
transmit one PSI report from the plurality of PSI reports based on prioritization to the network entity on the lower layer channel.

19. The UE of claim 18, wherein the lower layer channel comprises either a Physical layer channel or a Medium Access Control (MAC) layer channel.

20. The UE of claim 19, wherein the physical layer channel comprises either a physical uplink shared channel (PUSCH), a physical uplink control channel (PUCCH), or a physical sidelink shared channel (PSSCH), and the MAC layer channel comprises a MAC - control element (MAC-CE).

21. The UE of claim 18, wherein the at least one processor is configured to transmit the one PSI report from the plurality of PSI reports based on prioritization and to not transmit remaining PSI reports in the plurality of PSI reports.

22. The UE of claim 18, wherein the one or more priority rules based at least in part on the positioning related content comprise prioritizing a PSI report carrying a first type of positioning measurement over a PSI report carrying a second type of positioning measurements.

23. The UE of claim 18, wherein the one or more priority rules based at least in part on the positioning related content comprise prioritizing a PSI report carrying a timing measurement over a PSI report carrying only energy measurements.

24. The UE of claim 18, wherein the one or more priority rules based at least in part on the positioning related content comprise prioritizing a PSI report carrying first-arrival measurements over a PSI report carrying multipath measurements.

25. The UE of claim 18, wherein the one or more priority rules based at least in part on the positioning related content comprise prioritizing a PSI report carrying Reference Signal Time Difference (RSTD) measurements from an Time Difference of Arrival (TDOA) positioning session over a PSI report carrying Reference Signal Receive Power (RSRP) from the TDOA positioning session.

26. The UE of claim 18, wherein the one or more priority rules based at least in part on the positioning related content comprise prioritizing a PSI report carrying receive-transmit time difference (Rx-Tx) measurements from a multi-Round Trip Time (RTT) positioning session over a PSI report carrying Reference Signal Receive Power (RSRP) from the multi-RTT positioning session.

27. The UE of claim 18, wherein the one or more priority rules based at least in part on the positioning related content comprise prioritizing a PSI report carrying Reference Signal Receive Power (RSRP) measurements from an Angle of Departure (AOD) positioning session over a PSI report carrying timing measurements from the AOD positioning session.

28. The UE of claim 18, wherein the one or more priority rules based at least in part on the positioning related content comprise prioritizing a PSI report carrying multiple types of positioning measurement over a PSI report carrying a single type of positioning measurement.

29. The UE of claim 18, wherein the one or more priority rules based at least in part on the positioning related content comprise prioritizing a PSI report carrying positioning measurements from a reference Transmission Reception Point (TRP) over a PSI report carrying positioning measurement from only one or more neighboring TRPs.

30. The UE of claim 18, wherein the one or more priority rules based at least in part on the positioning related content comprise prioritizing a PSI report carrying timing or energy positioning measurement over a PSI report carrying velocity information.

31. The UE of claim 18, wherein the one or more priority rules based at least in part on the positioning related content comprise prioritizing a PSI report carrying positioning measurements derived from a downlink (DL) or uplink (UL) positioning reference signals (PRS) over a PSI report carrying positioning measurements derived from non-PRS signals.

32. The UE of claim 18, wherein the one or more priority rules based at least in part on the positioning related content comprise prioritizing a PSI report carrying one or more positioning fixes for the UE over a PSI report carrying positioning measurements.

33. The UE of claim 18, wherein the one or more priority rules based at least in part on the positioning related content comprise prioritizing a PSI report carrying a latest timestamp over a PSI report carrying an earlier timestamp.

34. The UE of claim 18, wherein the one or more priority rules based at least in part on the positioning related content comprise prioritizing a PSI report carrying positioning measurements derived from an intra-frequency measurement over a PSI report carrying positioning measurements derived from inter-frequency measurements, wherein intra-frequency measurements comprise measurements performed on the same positioning frequency layer and inter-frequency measurements comprise measurements performed across at least two different positioning frequency layers.

35-50. (canceled)

51. A method for a user equipment (UE) wireless communications performed by a network entity in a wireless network, comprising:
receiving from the UE a positioning state information (PSI) report in a lower layer channel, the PSI report comprising information related to positioning measurements performed by the UE, wherein the PSI report was prioritized over a second colliding PSI report using one or more priority rules based at least in part on positioning related content of the PSI report and the second colliding PSI report; and
processing the PSI report.

52-69. (canceled)

70. A network entity in a wireless network configured to support wireless communications of a user equipment (UE), comprising:
an external interface configured to wirelessly communicate with the UE;
at least one memory;
at least one processor coupled to the external interface and the at least one memory, wherein the at least one processor is configured to:
receive from the UE a positioning state information (PSI) report in a lower layer channel, the PSI report comprising information related to positioning measurements performed by the UE, wherein the PSI report was prioritized over a second colliding PSI report using one or more priority rules based at least in part on positioning related content of the PSI report and the second colliding PSI report; and
process the PSI report.

71. The network entity of claim 70, wherein the at least one processor is further configured to:
transmit a prioritization configuration of the priority rules based on positioning related content to the UE, wherein the PSI report was prioritized over the second colliding PSI report based on the prioritization configuration of the priority rules.

72. The network entity of claim 70, wherein the network entity comprises one of a location server, a serving base station, or a sidelink UE.

73. The network entity of claim 70, wherein the lower layer channel comprises either a Physical layer channel or a Medium Access Control (MAC) layer channel.

74. The network entity of claim 73, wherein the physical layer channel comprises either a physical uplink shared channel (PUSCH), a physical uplink control channel (PUCCH), or a physical sidelink shared channel (PSSCH), and the MAC layer channel comprises a MAC - control element (MAC-CE).

75. The network entity of claim 70, wherein the second colliding PSI report is not received from the UE.

76. The network entity of claim 70, wherein the one or more priority rules based at least in part on the positioning related content comprise prioritizing a PSI report carrying a first type of positioning measurement over a PSI report carrying a second type of positioning measurements.

77. The network entity of claim 70, wherein the one or more priority rules based at least in part on the positioning related content comprise prioritizing a PSI report carrying a timing measurement over a PSI report carrying only energy measurements.

78. The network entity of claim 70, wherein the one or more priority rules based at least in part on the positioning related content comprise prioritizing a PSI report carrying first-arrival measurements over a PSI report carrying multipath measurements.

79. The network entity of claim 70, wherein the one or more priority rules based at least in part on the positioning related content comprise prioritizing a PSI report carrying Reference Signal Time Difference (RSTD) measurements from an Time Difference of Arrival (TDOA) positioning session over a PSI report carrying Reference Signal Receive Power (RSRP) from the TDOA positioning session.

80. The network entity of claim 70, wherein the one or more priority rules based at least in part on the positioning related content comprise prioritizing a PSI report carrying receive-transmit time difference (Rx-Tx) measurements from a multi-Round Trip Time (RTT) positioning session over a PSI report carrying Reference Signal Receive Power (RSRP) from the multi-RTT positioning session.

81-108. (canceled)
